(19) United States
(12) Patent Application Publication
(10) Pub. No.: US 2012/0036153 A1
(43) Pub. Date: Feb. 9, 2012

(54) MOBILE SYSTEM, SEARCH SYSTEM AND SEARCH RESULT PROVIDING METHOD FOR MOBILE SEARCH

(75) Inventors: Ram LEE, Seongnam-si (KR); Man Ho WON, Uiwang-si (KR)

(73) Assignee: NHN CORPORATION, Seongnam-si (KR)

(21) Appl. No.: 13/198,015

(22) Filed: Aug. 4, 2011

(30) Foreign Application Priority Data
Aug. 4, 2010 (KR) 10-2010-0075194

(51) Int. Cl. G06F 17/30

(52) U.S. Cl. 707/770; 707/E17.014

(57) ABSTRACT

Provided is a search service providing system associated with a mobile system, and a method for providing a search result for a mobile terminal. The system may include a user interface unit to provide a search interface for selecting a search mode, a search request unit to receive search request information based on the search mode selected via the search interface, and to transfer the search request information to the search server, and a search result providing unit to receive a search result corresponding to the search request information from the search server, and to provide the search result. The search mode may include an audio search mode for providing a search result corresponding to input audio data, an image search mode for providing a search result corresponding to input image data, or both the audio search mode and the image search mode.

### CROSS-REFERENCE TO RELATED APPLICATION

This application claims priority from and the benefit of Korean Patent Application No. 10-2010-0075194, filed on Aug. 4, 2010, which is hereby incorporated by reference for all purposes as if fully set forth herein.

### BACKGROUND OF THE INVENTION

1. Field of the Invention

Exemplary embodiments of the present invention relate to a system, a search system to provide search services associated with a mobile system, and a method and apparatus for providing a_search result associated with a mobile search.

2. Description of the Background

Recently web based search service markets have been rapidly growing due to a large number of services involved with each other using a search engine based on a search portal site that provides users as a point of access to information on the World Wide Web. Radio communication systems, such as cellular systems, provide users with the convenience of mobility. Consequently, service providers recognize increased demand of various mobile services using the search engine.

However, due to a characteristic of a mobile terminal, for example, a small size and mobility, services providers have been challenged to continually provide enhanced search services. For instance, there exist constraints on inputting and outputting data for a search request and data for a search result.

Therefore, there is a need for an approach for providing enhanced mobile services and providing a method and system capable of efficiently performing various types of searches.

### SUMMARY OF THE INVENTION

These and other needs are addressed by the present invention, in which exemplary embodiments of the present invention provide a mobile system, a search system, and a search result providing method that may readily provide various types of search modes, for example, a text search, an audio search for obtaining a search result using a sound or searching for music, an image search for obtaining a search result using a word included in a picture or using the picture, a knowledge search for obtaining answers of other users about a query, an attribute search for obtaining a search result using an attribute suitable for a subject input by a user.

Additional features of the invention will be set forth in the description which follows, and in part will be apparent from the description, or may be learned by practice of the invention.

Exemplary embodiments of the present invention disclose a system to communicate with a search server over a wireless network. The system includes a user interface unit to provide a search interface for selecting a search mode. The system also includes a search request unit to receive a search request based on the selected search mode via the search interface, and to transfer the search request to the search server, wherein various contents are stored in a non-transitory storage medium of the search server. And the system includes a search result providing unit to receive a search result corresponding to the search request from the search server, and to provide the search result, the search result being searched from the non-transitory storage medium. The search mode comprises an audio search mode to provide a search result corresponding to input audio data, an image search mode to provide a search result corresponding to input image data, or both the audio search mode and the image search mode.

Exemplary embodiments of the present invention disclose an apparatus using a processor and a non-transitory storage medium to communicate with a mobile terminal for providing a search service. The apparatus includes a search mode verification unit, executed by the processor, to determine a search mode of search request information being received from the mobile terminal. The apparatus also includes a search result providing unit, executed by the processor, to verify a search result corresponding to the search request information based on the search mode, and to provide the verified search result by searching the verified search result from the non-transitory storage medium to the mobile terminal. The search mode comprises an audio search mode to provide a search result corresponding to input audio data, and an image search mode to provide a search result corresponding to input image data.

Exemplary embodiments of the present invention disclose a system for providing a search service associated with a terminal, the system to communicate with a search server comprising a processor and a non-transitory storage medium over a wireless network. The system includes a user interface unit to provide a search interface to select a subject of a search. The system also includes an attribute providing unit to provide, using the search interface, one or more attributes being predetermined based on a subject of an input search request via the search interface. The system includes a search request unit to transmit, to the search server, the search request according to the attribute selected from the one or more attributes. And the system also includes a search result providing unit to receive a search result corresponding to the search request from the search server, and to provide the search result, the search result being determined by searching the search request corresponding to the selected attribute from the non-transitory storage medium.

Exemplary embodiments of the present invention disclose a search system using a search server comprising a processor and a non-transitory storage medium to communicate with a mobile terminal to provide search services. The search system includes a search request receiver, executed by the processor, to receive search request information from the mobile terminal. The search system includes a search result providing unit, executed by the processor, to verify a search result by searching the search result from the non-transitory storage medium, the searching being performed according to at least one attribute of the search request information, and to provide the search result to the mobile terminal. The at least one attribute comprises at least one attribute among attributes associated with a subject of a search being selected by the mobile terminal.

Exemplary embodiments of the present invention disclose a method using a processor for providing a search result in a mobile system via a wireless network. The method includes providing a search interface for selecting a search mode. The method includes receiving search request information based on the search mode selected via the search interface to transfer the search request information to a search server. The method also includes receiving a search result corresponding to the search request information by searching, by the processor, the search request information according to the selected search mode to provide the search result. The search mode includes an audio search mode for providing a search result corresponding to input audio data, an image search mode for providing a search result corresponding to input image data, or both the audio search mode and the image search mode.

Exemplary embodiments of the present invention disclose a method of providing a search service using a search server to a mobile terminal via a network. The method includes determining, by a processor, a search mode associated with search request information being received from the mobile terminal. The method also includes verifying, by the processor, whether a search result corresponding to the search request information is matched with the search mode to provide the search result to the mobile terminal. The search mode incldues an audio search mode for providing a search result corresponding to input audio data, an image search mode for providing a search result corresponding to input image data, or both the audio search mode and the image search mode.

Exemplary embodiments of the present invention disclose a method using a processor for providing a search service associated with a mobile system via a wireless network. The method includes providing a search interface to select a subject of a search category. The method also includes generating a plurality of attributes, by a processor, using the search interface in response to detection of a search request corresponding to the search category. The method includes transmitting the search request according to the attribute being selected from the plurality of the attributes. And the method includes receiving a search result corresponding to the search request to provide the search result.

Exemplary embodiments of the present invention disclose a computer-implemented method for providing a search service using a search system to communicate with a mobile terminal. The method includes receiving search request from the mobile terminal. The method also includes providing one or more attributes corresponding to the received search request, the one or more attributes being provided based on determining, by a processor, a subject of the search request and being selected by an user using an interface to verify the search request. A search result is provided to the user according to the selected attributes.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a mobile terminal and a search server according to exemplary embodiments of the present invention.

FIG. 2 is a block diagram illustrating a configuration of a mobile system according to exemplary embodiments of the present invention.

FIG. 3 illustrates an exemplary screen for displaying a search interface according to exemplary embodiments of the present invention.

FIG. 4 illustrates an exemplary screen for displaying a search interface according to exemplary embodiments of the present invention.

FIG. 5 illustrates an exemplary screen for displaying popular keywords according to exemplary embodiments of the present invention.

FIG. 6 illustrates an exemplary screen for displaying a shortcut function to services provided from a search server according to exemplary embodiments of the present invention.

FIG. 7 illustrates an exemplary screen for displaying an interface for a text search according to exemplary embodiments of the present invention.

FIG. 8 is a flowchart of a process for illustrating a barcode search method according to exemplary embodiments of the present invention.

FIG. 9 illustrates an exemplary screen for recognizing barcode information in an image according to exemplary embodiments of the present invention.

FIG. 10 illustrates an exemplary screen for displaying a search result found through a barcode search and a search history according to exemplary embodiments of the present invention.

FIG. 11 illustrates exemplary screen for displaying an interface for receiving a barcode from a user according to exemplary embodiments of the present invention.

FIG. 12 illustrates an exemplary screen for extracting a text in an image and for displaying a search result based on the extracted text according to exemplary embodiments of the present invention.

FIG. 13 illustrates an exemplary screen for extracting a text in an image and for displaying the text structuralized for each item according to exemplary embodiments of the present invention.

FIG. 14 is a flowchart of a process for illustrating a sound search method according to exemplary embodiments of the present invention.

FIG. 15 illustrates an exemplary screen for recognizing a sound of a user according to exemplary embodiments of the present invention.

FIG. 16 illustrates an exemplary screen for displaying a search result found based on a recognized sound according to exemplary embodiments of the present invention.

FIG. 17 is a flowchart of a process for illustrating a sound search method according to exemplary embodiments of the present invention.

FIG. 18 illustrates an exemplary screen for recognizing music desired to be found according to exemplary embodiments of the present invention.

FIG. 19 illustrates an exemplary screen for displaying a search result found based on a music search according to exemplary embodiments of the present invention.

FIG. 20 is a flowchart of a process for illustrating a knowledge search method according to exemplary embodiments of the present invention.

FIG. 21 illustrates an exemplary screen for receiving a query from a user and for providing a search result corresponding to the query according to exemplary embodiments of the present invention.

FIG. 22 illustrates an exemplary screen for displaying answers in response to an input query according to exemplary embodiments of the present invention.

FIG. 23 illustrates an exemplary screen for displaying attributes corresponding to an input subject and for displaying a search result about a selected attribute according to exemplary embodiments of the present invention.

FIG. 24 illustrates an exemplary screen for displaying attributes corresponding to an input subject and for displaying a search result about a selected attribute according to exemplary embodiments of the present invention.

FIG. 25 illustrates an exemplary screen for displaying attributes corresponding to an input subject and for displaying a search result about a selected attribute according to exemplary embodiments of the present invention.

FIG. 26 illustrates an exemplary screen for displaying attributes corresponding to an input subject and for displaying a search result about a selected attribute according to exemplary embodiments of the present invention.

FIG. 27 illustrates an exemplary screen for displaying attributes corresponding to an input subject and for displaying a search result about a selected attribute according to exemplary embodiments of the present invention.

FIG. 28 is a flowchart of a process for illustrating a search result providing method executable at a mobile system according to exemplary embodiments of the present invention.

FIG. 29 is a block diagram illustrating a configuration of a search system according to exemplary embodiments of the present invention.

FIG. 30 is a flowchart of a process for illustrating a search result providing method executable at a search system according to exemplary embodiments of the present invention.

FIG. 31 is a block diagram for illustrating a configuration of a mobile system according to exemplary embodiments of the present invention.

FIG. 32 is a flowchart of a process for illustrating a search result providing method executable at a mobile system according to exemplary embodiments of the present invention.

FIG. 33 is a block diagram for illustrating a configuration of a search system according to exemplary embodiments of the present invention.

FIG. 34 is a flowchart of a process for illustrating a search result providing method executable at a search system according to exemplary embodiments of the present invention.

FIG. 35 is a diagram of hardware that can be used to implement exemplary embodiments of the invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like reference numerals in the drawings denote like elements.

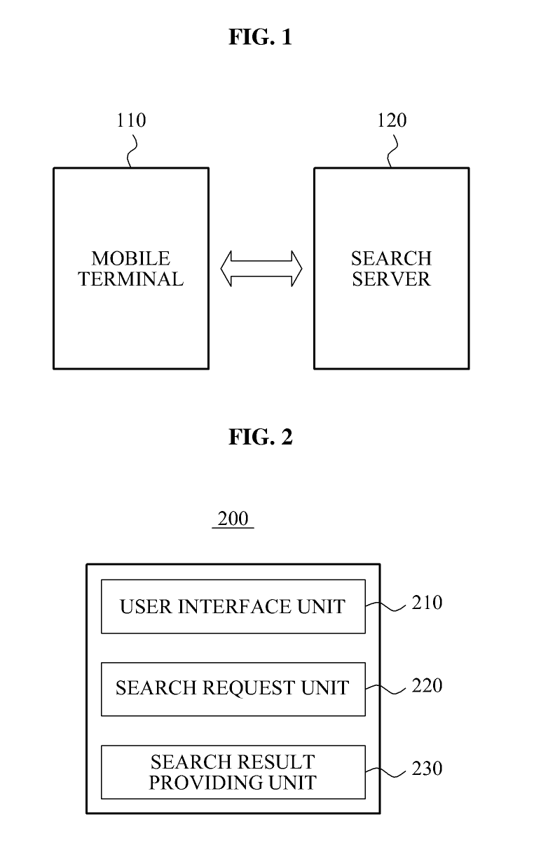

FIG. 1 is a block diagram illustrating a mobile terminal 110 and a search server 120 according to exemplary embodiments of the present invention. For example, the mobile terminal 110 may provide various types of search modes via a search interface, and may receive a search mode selected by a user and data corresponding to the selected search mode, and may transmit the received search mode and data to the search server 120. In this example, the mobile terminal 110 may display various search services on a single screen via the search interface, thereby enabling the user to conveniently use various services that are provided from the search service 120, using the mobile terminal 110 having some constraints in input and output.

It is noted that even though the search server 120 is configured as a single server in FIG. 1, a plurality of search servers may be configured to provide various services provided from a single service provider.

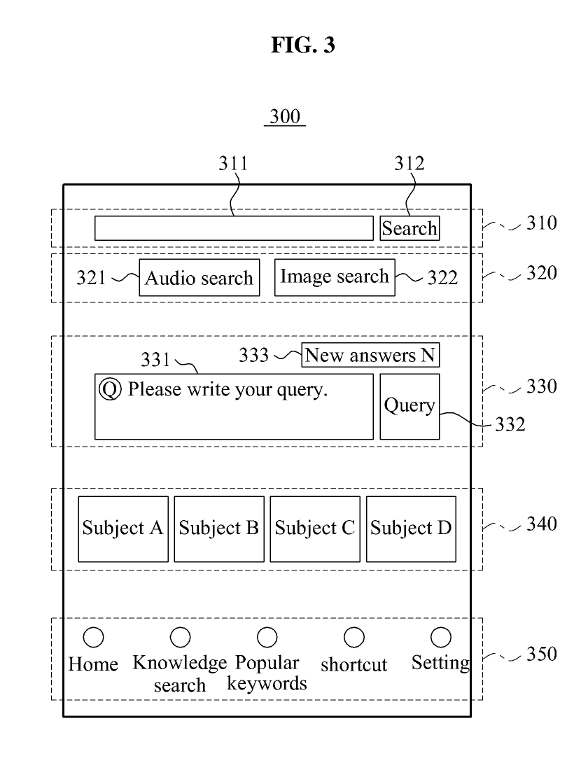

FIG. 2 is a block diagram illustrating a configuration of a mobile system 200 according to exemplary embodiments of the present invention. The mobile system 200, for example, may correspond to the mobile terminal 110 described above with reference to FIG. 1 and thus, may communicate with a search server over a wireless network. The search server may couple to the search server 120 of FIG. 1 for communications.

Referring to FIG. 2, for example, the mobile system 200 may include a user interface unit 210, a search request unit 220, and a search result providing unit 230.

The user interface unit 210 may provide a search interface for selecting a search mode. The search mode may include at least one of (1) an audio search mode for providing a search result corresponding to input audio data, (2) an image search mode for providing a search result corresponding to input image data, (3) a knowledge search mode for providing, as a search result, answer data corresponding to input query data, (4) an attribute search mode for providing a search result that satisfies a criterion according to an attribute of an input subject, or any combination of the illustrated search modes. Each search mode may be used to generate or provide additional information based on position information of the mobile system 200. A method of using position information will be further described later.

For example, the audio search mode may include a sound search mode for providing a search result corresponding to a text extracted from the input audio data, and an audio content data search mode for providing a search result about content including at least the input audio data. For example, the sound search mode may be used to extract a text from a sound of a user and to perform search based on the extracted text. In addition, the audio content data search mode may be used to record music and media coming from a street, and to receive the recorded music as audio data and thereby search for content including the corresponding music or information about the content.

The image search mode, for example, may include an image text based search mode, an image content data search mode, an image text storage mode, or any combination thereof.

The image text based search mode may be used to provide the search result corresponding to the text that is extracted from the input image data and thus, may be used to recognize text information included in a photographed picture and to perform search based on the text information. As an example, the image text based search mode may be used to recognize a barcode and search for information about a product corresponding to the barcode. For example, the image text based search mode may be used to photograph a sign while traveling and search for a lexical meaning of a word included in the sign, or to recognize a sentence written in the sign and automatically to translate the sentence.

The image content data search mode may be used to provide the search result about content including at least the input image data. As an example, the image content data search mode may be used to search for information about a corresponding movie based on an image such as a scene of the movie, or to obtain information about a music album based on a photo included in the music album. For example, the image content data search mode may be used to take a picture of a predetermined building and to provide information about the building as a search result, or to provide, as the search result, information about a person using a picture of the person.

The image text storage mode may be used to structuralize the text, extracted from the input image data, for each item, and to store the structuralized text. As an example, the image text storage mode may be used to recognize text information such as in a name card. For example, the image text storage mode may be used to extract information from the photographed name card image, text information such as a name, an address, a telephone number, and a title and to structuralize the extracted information and to store the name, the address, the telephone number, and the title for each item.

The knowledge search mode may be used to provide, as the search result, answer data corresponding to the input query data. The answer data may be displayed on a webpage associated with the search server. When another user uploads answer data with respect to query data that is displayed on the webpage, the answer data may be provided to the user using the mobile system 200.

The attribute search mode may be used to provide the user with attributes about a given subject, and to provide search results about attributes selected by the user. The attribute search mode enables the user to obtain a desired search result even though the user is unaware of a keyword required to search for the desired search result. For example, when the user desires to be aware of semi-midsized vehicles having a first grade fuel efficiency and priced between ten million won to twenty million won, the attribute search mode may provide attributes such as a fuel efficiency, a price, and a size under a subject “vehicle,” and the user may obtain search results about vehicles corresponding to the desired attributes. In this example, the user may sequentially select the subject and attributes, for example, “vehicle,” “fuel efficiency,” and “first grade”, and thereby obtain the desired search result. The search result may be provided based on the subject and the attribute. For example, the search result associated with “ingredient/recipe” may be provided as the search result associated with a characteristic of ingredient or the search result about the recipe of a predetermined dish. Also, when a predetermined search result is selected from the user, the mobile system 200 may extract a text from the selected search result and may provide an additional search result by employing the extracted text as a keyword. A method of providing an additional search result will be further described later.

For example, the search request unit 220 may receive search request information based on the search mode selected via the search interface, and may transfer the search request information to the search server. The search request unit 220 may generate search request information for each of various types of data based on various search modes. As an example, various types of data such as text data, audio data, and image data may need to be transferred to the search server based on the search mode. For the above operation, the search request information may further include at least information about the search mode selected via the search interface, in addition to data that is to be transferred.

The search result providing unit 230, for example, may receive a search result corresponding to search request information from the search server, and may provide the search result. For example, as described above, answer data may be displayed on the webpage associated with the search server in the knowledge search mode. In this example, when answer data of another user is displayed on the webpage in response to the query data, the search result providing unit 230 may receive the answer data as the search result and provide the answer data to the user. In addition, the search result providing unit 230 may receive, from the search server, the search result corresponding to search request information that is transmitted based on each search mode, and may provide the search result to the user. For example, when an attribute of a predetermined subject is selected by the user in the attribute search mode, the search result providing unit 230 may receive, from the search server, the search result that satisfies the criterion according to the selected attribute, and may provide the search result to the user. When the attribute selected by the user is changed, the search result providing unit 230 may dynamically change the search result based on the changed attribute and thereby provide the dynamically changed search result to the user.

As described above, when one of search results provided via the attribute search mode is selected by the user, the mobile system 200 may extract a text from the selected search result, and perform a unified search by employing the extracted text as a keyword, thereby providing the search result to the user.

For example, the mobile system 200 may further include a database (not shown). The database may include various contents stored by the user. The mobile system 200 may add, to the received search result, a search result found by searching the database based on a corresponding search mode, thereby providing the search result to the user. Also, the mobile system 200 may obtain the search result using the search server when no search result is found by searching the database.

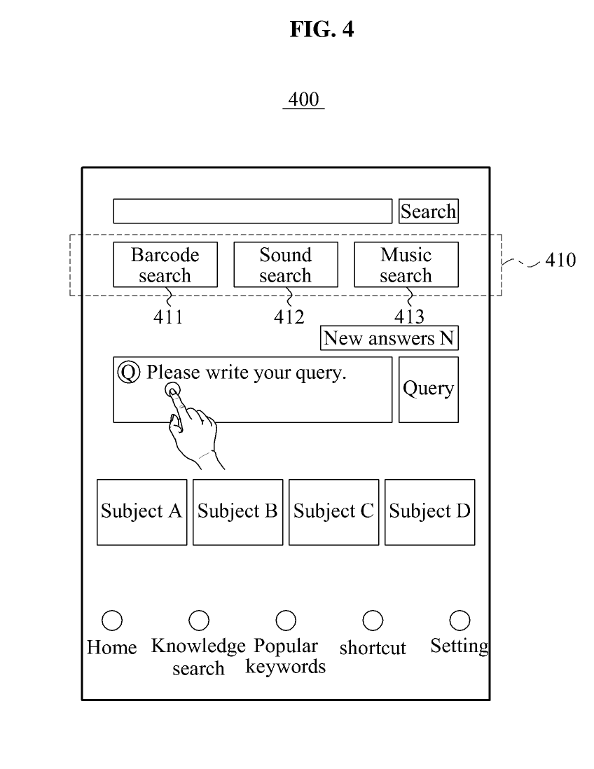

FIG. 3 illustrates an exemplary screen 300 for displaying a search interface according to exemplary embodiments of the present invention. The screen 300 may display a search interface of a mobile terminal. The search interface of FIG. 3 is an example and thus, may be variously modified based on a position of the search interface, a configuration thereof.

In FIG. 3, a first dotted box 310 is to describe an interface for a text search, and may include a field 311 for inputting a keyword and an interface 312 for initiating a search using the input keyword.

For example, a second dotted box 320 may include an interface 321 for selecting an audio search mode and an interface 322 for selecting an image search mode. Although only the interface 321 for selecting the audio search mode and the interface 322 for selecting the image search mode are shown in FIG. 3, an interface for a sound search mode including an audio search mode, an audio content data search mode, and an image text based search mode including an image search mode may be provided. The search mode may be expressed as an interface indicating a predetermined function, for example, a barcode search, a name card search, a sound search, and a music search.

A third dotted box 330 may correspond to an area associated with a knowledge search mode, and include a field 331 for inputting query data, an interface 332 for initiating a knowledge search based on input query data, and an interface 333 for indicating whether answer data is found through the knowledge search. Whether the answer data is found may be expressed based on “N” in “new answers N”.

A fourth dotted box 340 may correspond to an area associated with an attribute search and may display various subjects. When subjects desired to be displayed are not displayed on the area at a time, a plurality of subjects may be displayed on the area using a scroll function, or a page selected from a plurality of pages may be displayed on the area. Also, the area associated with the fourth dotted box 340 may be configured to receive a desired subject from the user.

A fifth dotted box 350 may include an interface for displaying Home on the screen, an interface for providing a main screen of a knowledge search, an interface for providing popular keywords, an interface for providing a shortcut function with respect to services provided from the search server, and an interface for setting various environments.

FIG. 4 illustrates an exemplary screen 400 for displaying a search interface according to exemplary embodiments of the present invention. The screen 400 displays a search interface of a mobile terminal. In FIG. 4, a dotted box 410 displays an area including an interface 411 for a barcode search, an interface 412 for a sound search, and an interface 413 for a music search by embodying an audio search mode and an image search mode. Depending on embodiments, for examples, other interfaces may be added or a displayed interface describe above may be removed by a configuration.

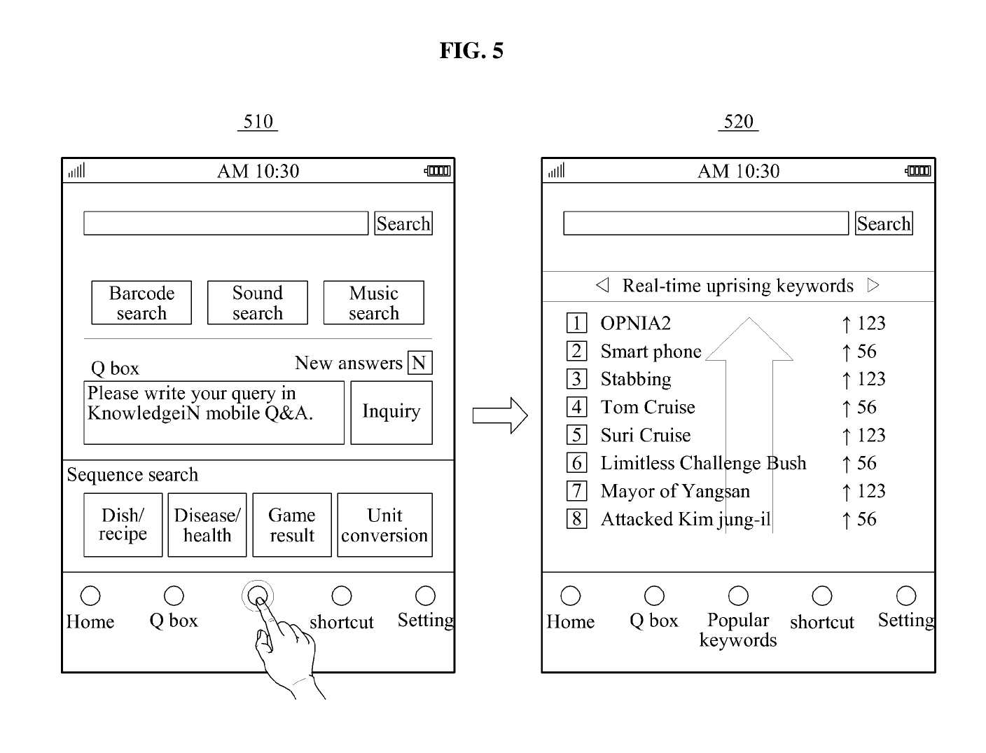

FIG. 5 illustrates an exemplary screen for displaying popular keywords according to exemplary embodiments of the present invention. A first screen 510 shows an example of selecting, by a user, an interface for providing popular keywords from among interfaces displayed in a lower end of Home. A second screen 520 shows an example in which when the interface for providing popular keywords is selected by the user, real-time uprising keywords of which a number of inputs rapidly increases are displayed for each ranking. Information about the real-time uprising keywords may be received via the search server. For example, when the interface for providing the popular keywords is selected by the user in the mobile system 200 of FIG. 2, the mobile system 200 may request the search server for information about the real-time uprising keywords and the search server may provide corresponding information to the mobile system 200 in response to the request. In this example, the mobile system 200 may display the provided information for the user as shown in the second screen 520. Information about the real- time uprising keywords may be received via the search server at predetermined time intervals and thereby be updated.

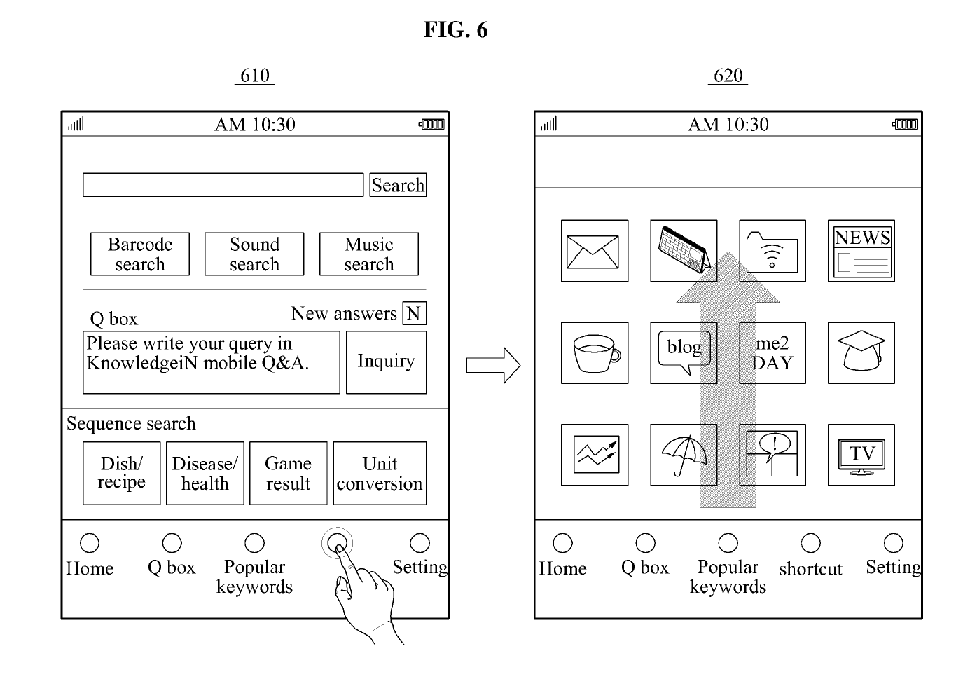

FIG. 6 illustrates an exemplary screen for displaying a shortcut function to services provided from a search server according to exemplary embodiments of the present invention. A first screen 610 shows an example of selecting, by a user, an interface for providing a shortcut function with respect to services, provided from a search server, from among interfaces displayed in a lower end of Home. A second screen 620 shows an example in which when the interface for providing the shortcut function is selected by the user, a shortcut list to the services is displayed. For example, a portal site may provide various services such as a mail, news, café, and blog as well as a search function. The shortcut function for the services may also be provided.

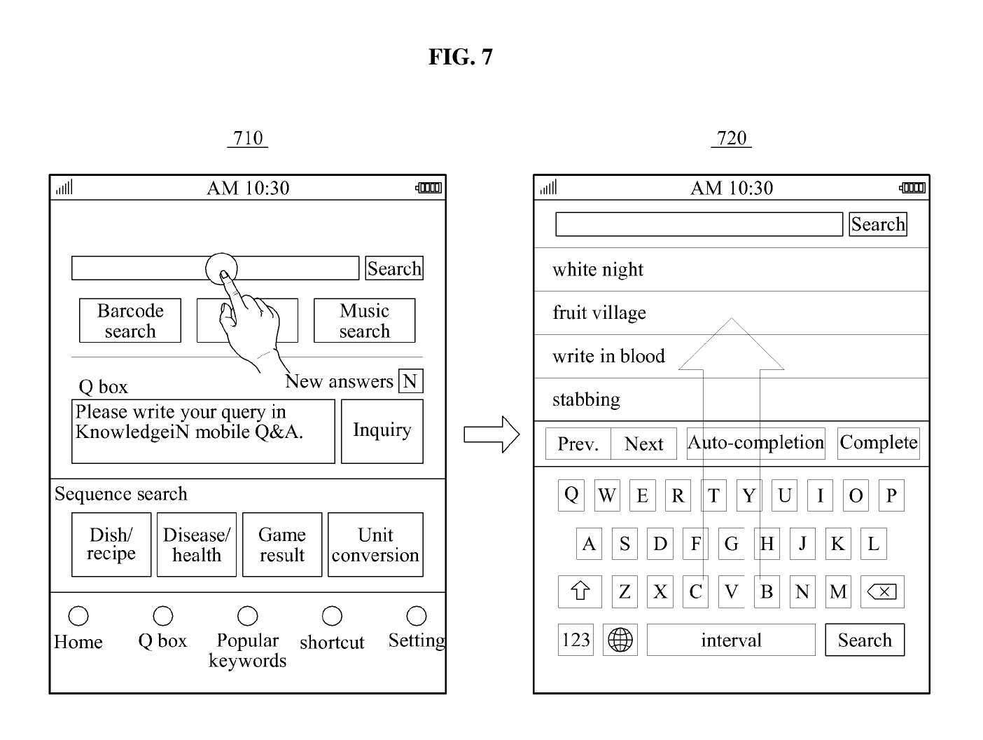

FIG. 7 illustrates an exemplary screen for displaying an interface for text search according to exemplary embodiments of the present invention. A first screen 710 shows an example of selecting, by a user, a field for a keyword input, and a second screen 720 corresponds to a screen provided when the field is selected by the user. The second screen 720 may simultaneously provide, to the user, an interface for inputting a text and a search history that is information about keywords previously input by the user. The search history may also include a keyword input based on a sound search. When the search history is deleted or does not exist in the interface displayed on the second screen 720, a function of displaying a search guide text may be further included.

For example, an auto-completion function may be provided in a keyword input field.

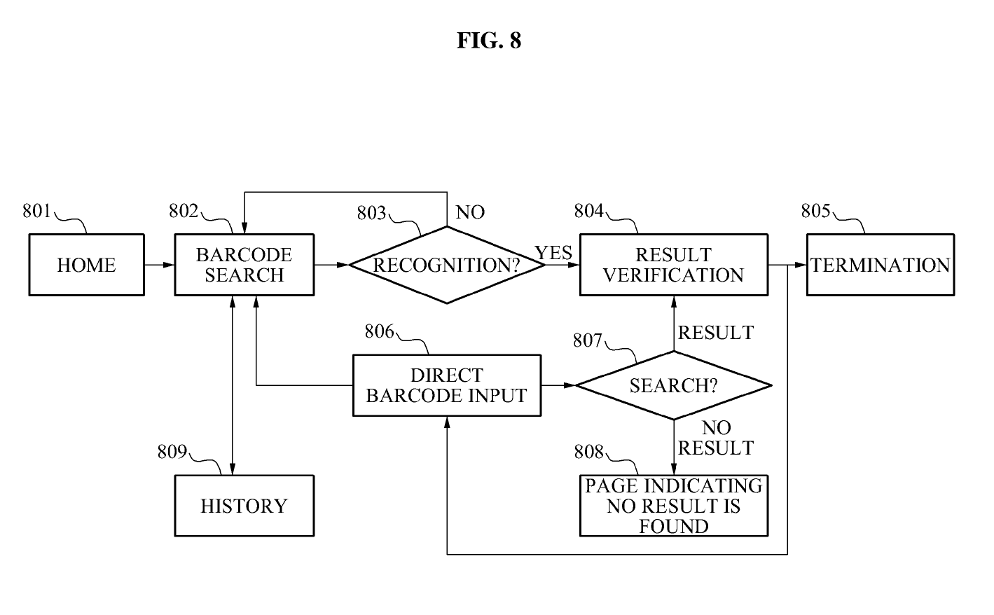

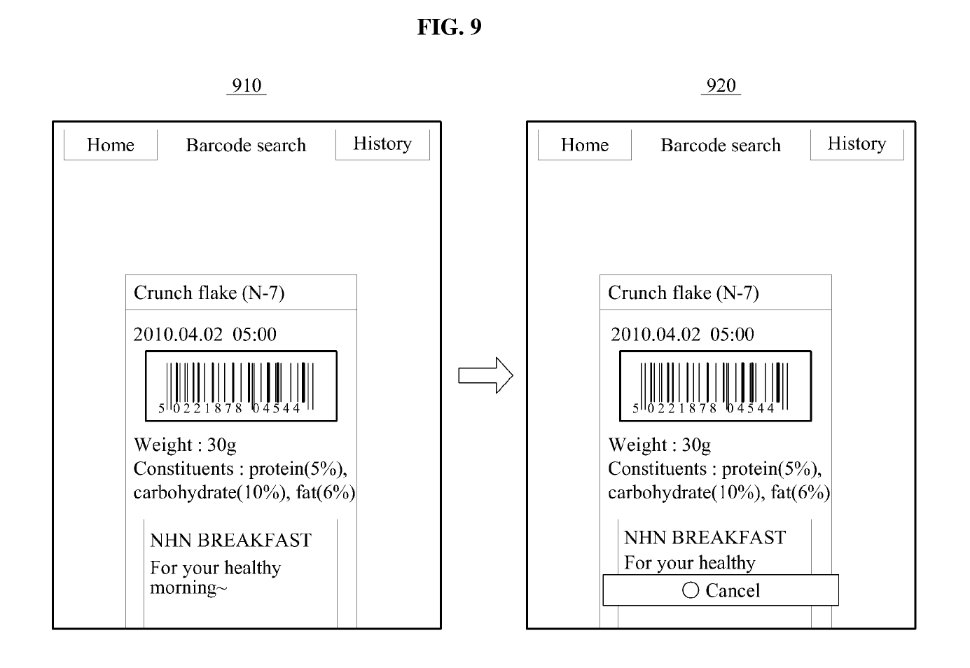

FIG. 8 is a flowchart of a process for illustrating a barcode search method according to exemplary embodiments of the present invention. When a barcode search 802 is selected on a screen displaying Home 801, the mobile system 200 may display the screen for the barcode search 802, thereby requesting a user to input a barcode image. In this example, a recognition operation 803 for recognizing a barcode in image data input from the user through photographing may be performed. When the barcode is recognized in the recognition operation 803, the mobile system 200 may transmit information about the recognized barcode to the search server, and may receive the search result from the search server. When the recognition fails in the recognition operation 803, the user may be requested to input again image data depending on necessities.

The search result may be displayed, for the user, on a screen for a result verification in step 804, and information about whether the user is satisfied with the search result may be received. When the user is determined to be satisfied with the search result, the barcode search 802 may be terminated in step 805 whereby the Home screen may be displayed again. Conversely, when the user is determined to be dissatisfied with the search result, a screen for a direct barcode input 806 may be displayed for the user. The mobile system 200 may transfer information about a directly input barcode to the search server and receive the search result, a search operation 807 may be performed. When the search result is present, the screen for the result verification in step 804 may be displayed again. Conversely, when the search result is absent, per step 808, a page indicating no search result is found may be displayed for the user.

For example, an interface for providing a history 809 of barcode search may be displayed on the screen for the barcode search.

FIG. 9 illustrates an exemplary screen for recognizing barcode information in an image according to exemplary embodiments of the present invention. For example, a first screen 910 shows an example of displaying image data input through photographing, and selecting a barcode area in the image data. A second screen 920 shows an example of recognizing a barcode in the selected area.

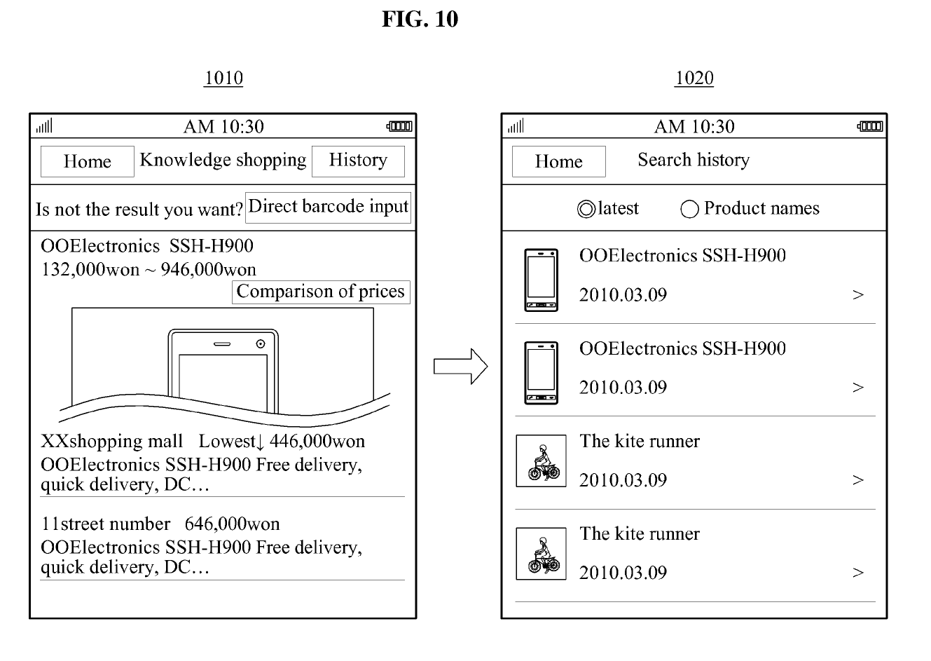

FIG. 10 illustrates an exemplary screen for displaying a search result found through a barcode search and a search history according to exemplary embodiments of the present invention. A first screen 1010 shows a search result about a product found using a barcode recognized from input image data. A second screen 1020 shows a history of a barcode search. For example, on the second screen 1020, it is possible to verify found products and a corresponding search date. Information about the products may be provided in a thumbnail form or be sorted based on a latest date or a product name. The thumbnail may include a link to a page including information about a corresponding product.

When a picture of the barcode is taken using a camera, a photographing mode may be automatically performed without a separate camera button. Instead of using the camera, image data may be downloaded from the Internet, or photographed and thereby stored image data may be used.

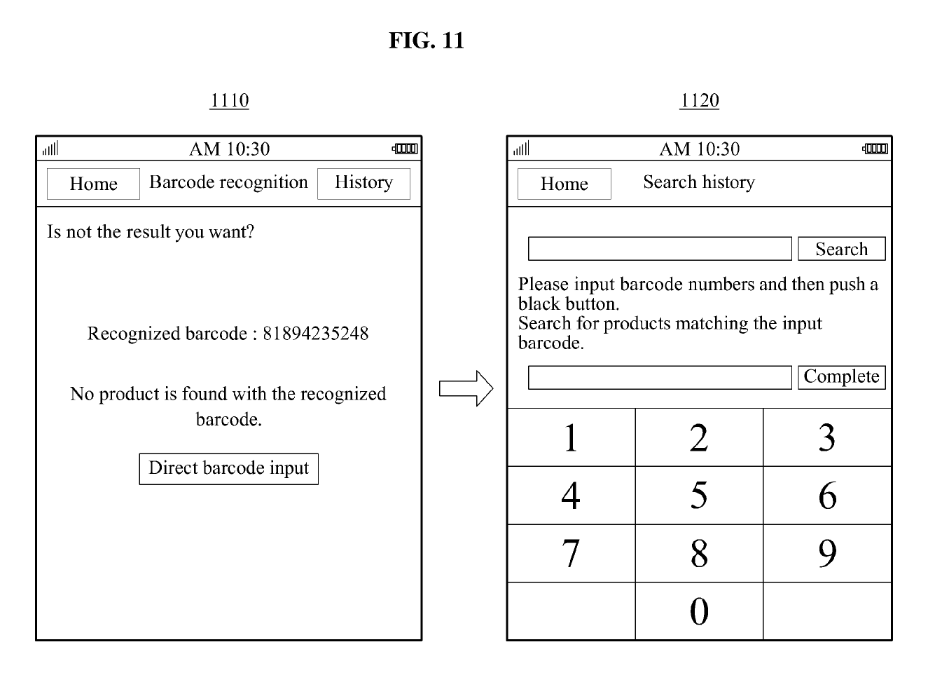

FIG. 11 illustrates an exemplary screen for displaying an interface for receiving a barcode from a user according to exemplary embodiments of the present invention. When the user is not satisfied with the search result found through the barcode search, or when the search result is not found, the user may directly input the barcode. A first screen 1110 shows an example of asking the user whether to directly input the barcode when the search result is not found. Also, a second screen 1120 shows an example of displaying, for the user, an interface including a number keypad for inputting numbers included in a lower end of the barcode.

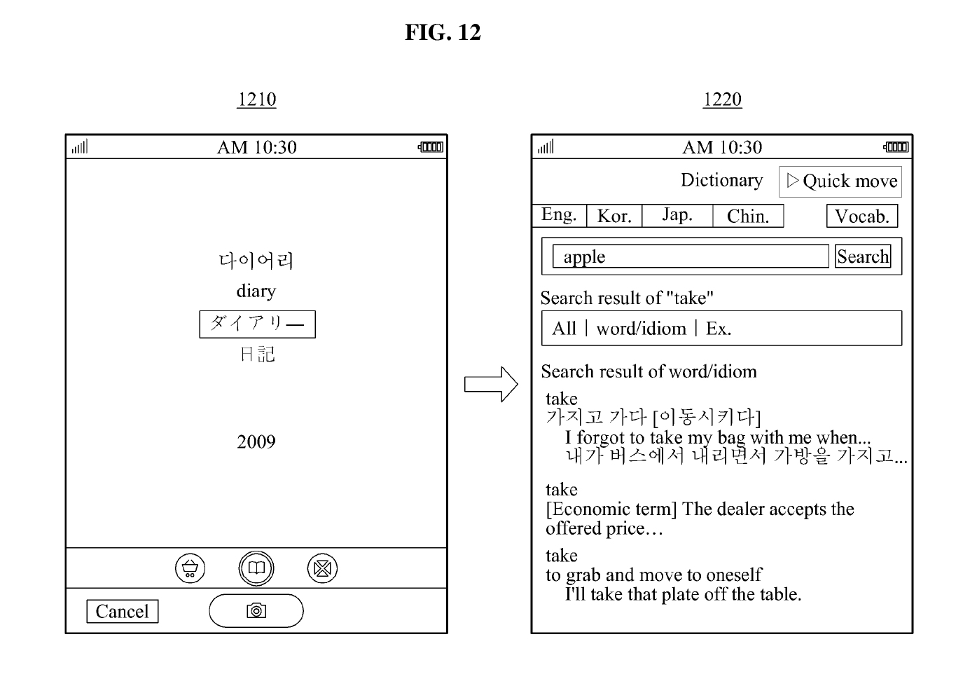

FIG. 12 illustrates an exemplary screen for extracting a text in an image and displaying a search result based on the extracted text according to exemplary embodiments of the present invention. As described above, for example, when an image search mode is selected, the mobile system 200 may perform image search based on image data that is photographed using a camera, or image data that is downloaded from the Internet or is pre-stored in the mobile system 200. A first screen 1210 shows an example of an extracted text of an area set by the user, from the input image data. A second screen 1220 shows an example of finding a lexical meaning by employing the extracted text as a keyword. For example, on the second screen 1220, the extracted text is input as the keyword in a keyword input field of a screen for a dictionary.

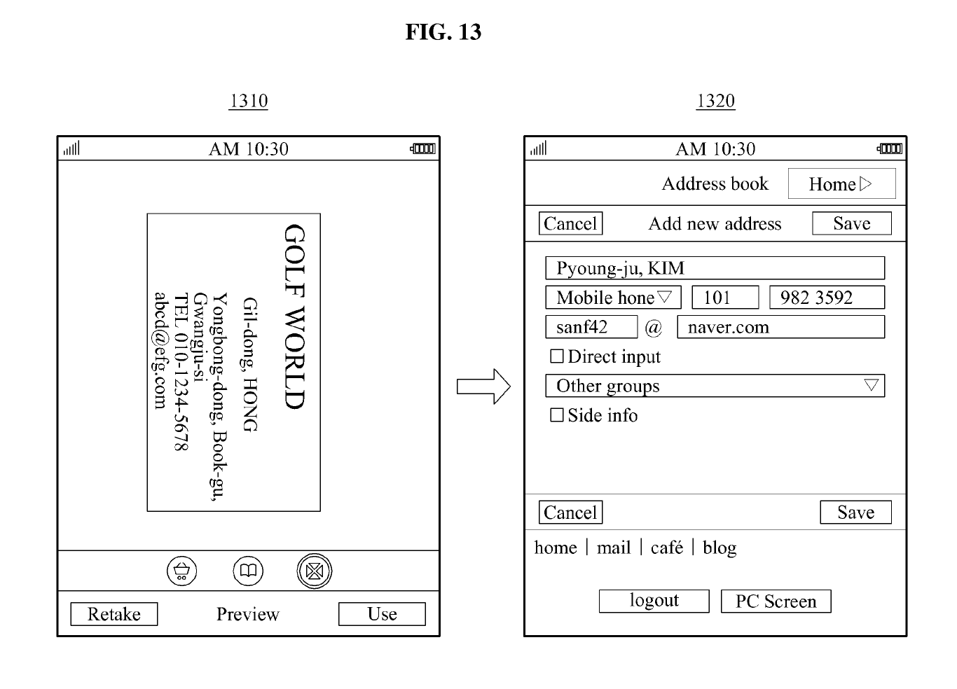

FIG. 13 illustrates an exemplary screen for extracting a text in an image and displaying the text structuralized for each item according to exemplary embodiments of the present invention. FIG. 13 illustrates an example of recognizing a name card. A first screen 1310 shows an example of extracting a text from an image photographed from the name card, and a second screen 1320 shows an example of structuralizing items, for example, a name, a telephone number, and an email address that are included in the name card, and displaying the structuralized items for the user. Each of the items displayed on the screen 1320 may be modified by the user, or be stored in a storage area of the search server or the mobile system 200.

In this example, when the name card search is performed, however, an image text based search mode is selected for the name card in FIG. 13, the mobile system 200 may extract a name of a person from the image of the name card to search for the person, or may extract a company name from the image of the name card to search for information about the company.

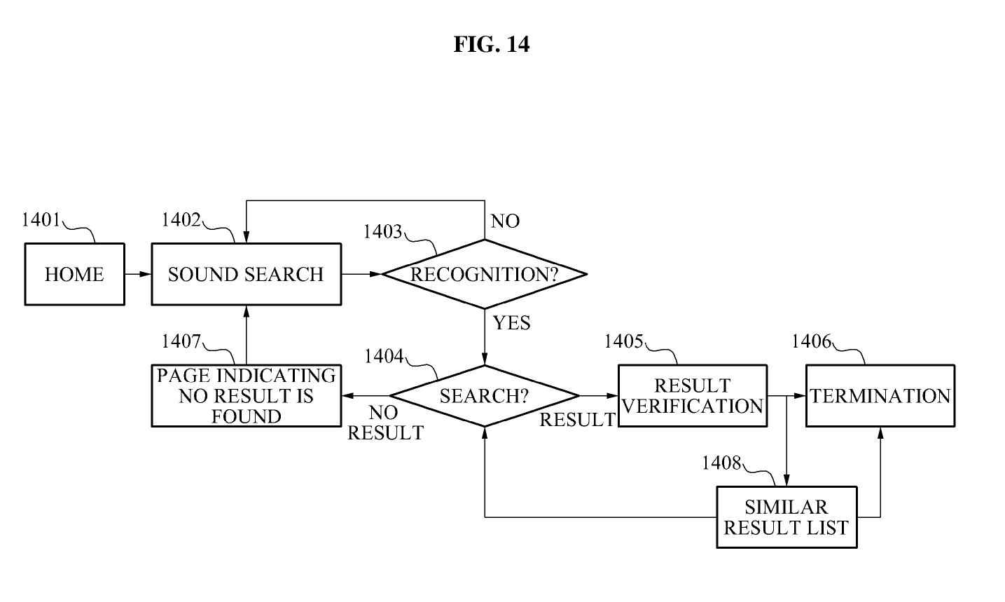

FIG. 14 is a flowchart of a process for illustrating a sound search method according to exemplary embodiments of the present invention. When a sound search 1402 is selected on a screen displaying Home 1401, the mobile system 200 may request a user to select a sound by displaying a screen for the sound search 1402. Here, the mobile system 200 may perform a recognition operation 1403 of recognizing a text by recording a sound of the user using a recording function and by extracting the text from the recorded sound. When the text is recognized, the mobile system 200 may perform a search operation 1404 of transmitting information about the recognized text to the search server and receiving the search result from the search server. When the recognition fails in the recognition operation 1403, the mobile system 200 may request the user to input again the sound depending on necessities.

The search result may be displayed, for the user, on a screen for a result verification in step 1405, and information about whether the user is satisfied with the search result may be received. When the user is determined to be satisfied with the search result, the sound search, per step 1402, may be terminated in operation 1406 whereby the Home screen may be displayed again. Conversely, when the user is determined to be dissatisfied with the search result, the search process in step 1404 may be repeated using texts similar to the text recognized by the user through a screen for providing a similar result list in step 1408. When the search result about the text is not found in the search operation in step 1404, a page indicating no search result is found, per step 1407, may be displayed for the user and the screen for the sound search in step 1402 may be displayed again for the user.

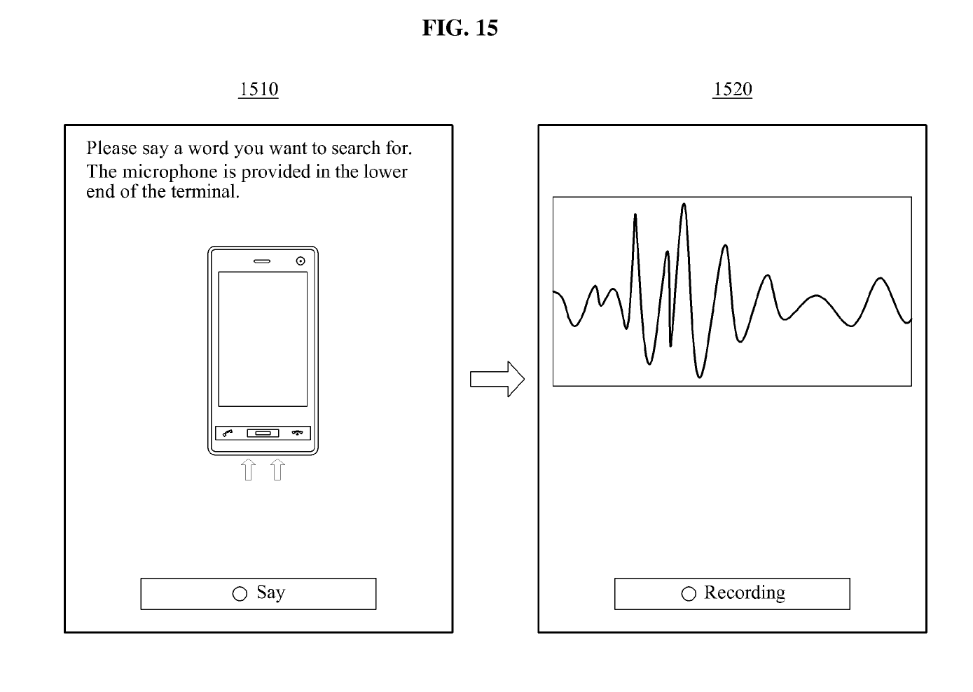

FIG. 15 illustrates an exemplary screen for recognizing a sound of a user according to exemplary embodiments of the present invention. A first screen 1510 shows an example of requesting a user to say a word required for search through a microphone included in a lower end of a terminal, and a second screen 1520 shows an example of recording a sound of the user. When the sound of the user is recorded, the mobile system 200 may extract a text from the recorded sound.

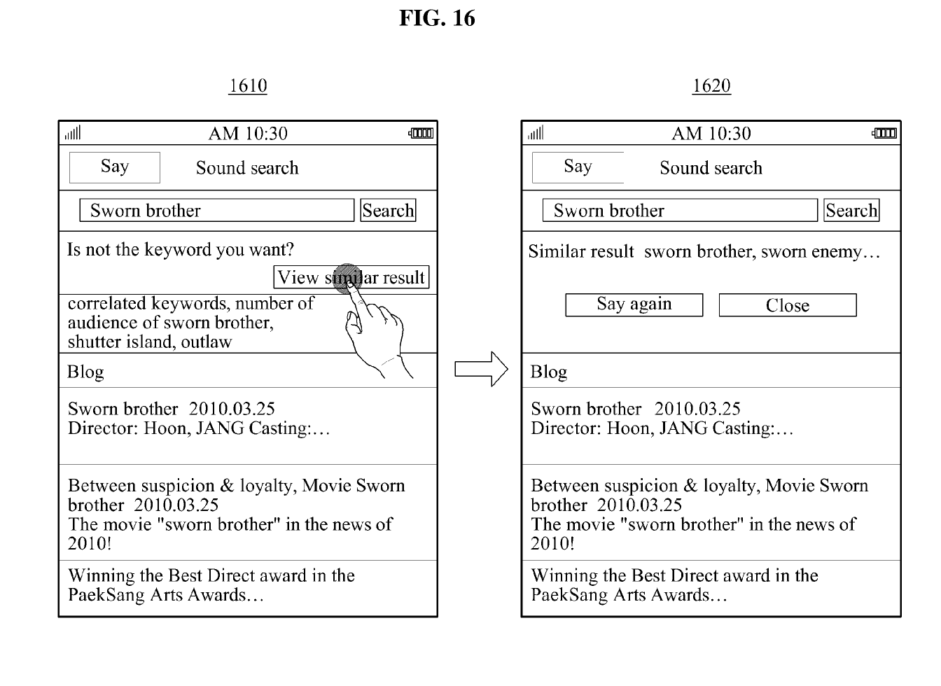

FIG. 16 illustrates an exemplary screen for displaying a search result found based on a recognized sound according to exemplary embodiments of the present invention. A first screen 1610 shows an example of displaying a search result by employing an extracted text as a keyword. A second screen 1620 shows an example of providing words similar to the extracted text when “view similar result” is selected on the first screen 1610. Also, the second screen 1620 displays an interface for requesting the user to input the sound of the user again.

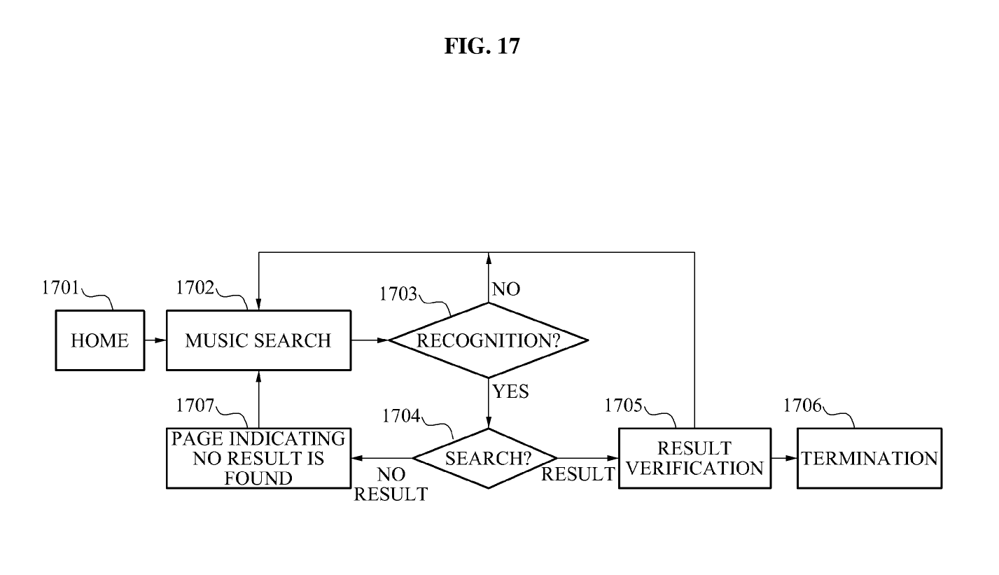

FIG. 17 is a flowchart illustrating a sound search method according to an exemplary embodiment of the present invention. When a music search in step 1702 is selected on a screen displaying Home, per step 1701, the mobile system 200 may display a screen for the music search in step 1702, thereby requesting the user to input a sound source via a microphone. For example, the mobile system 200 may perform a recognition operation, per step, 1703 of recording the sound source input using a recording function. In step 1704, a search operation of transmitting the recorded sound source to the search server and receiving the search result from the search server may be performed. When the recognition fails in the recognition operation, per step 1703, the mobile system 200 may request the user to input again the sound depending on necessities.

The search result may be displayed, for the user, on a screen for a result verification in step 1705 and information about whether the user is satisfied with the search result may be received. When the user is determined to be satisfied with the search result, the music search, per step 1702, may be terminated in operation in step 1706 whereby the Home screen may be displayed again. When the search result about the text is not found in the search operation in step 1704, per step 1707, a page indicating no search result is found may be displayed for the user and the screen for the music search in step 1702 may be displayed again for the user.

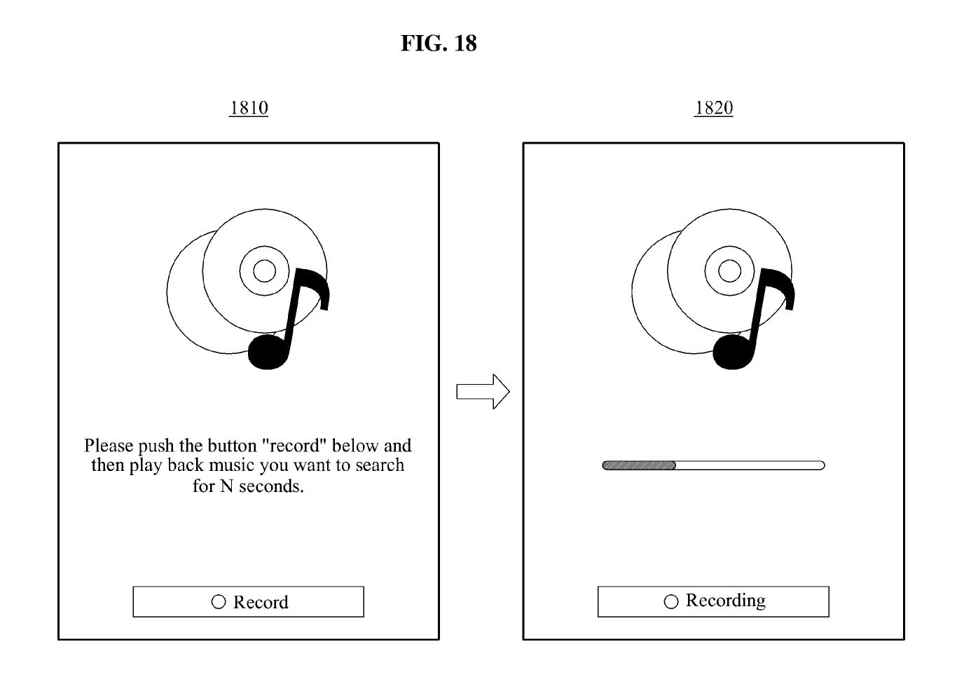

FIG. 18 illustrates an exemplary screen for recognizing music desired to be found according to exemplary embodiments of the present invention. A first screen 1810 shows an example of requesting a user to play back music desired to be found for N seconds, and a second screen 1820 shows an example of recording music being played back.

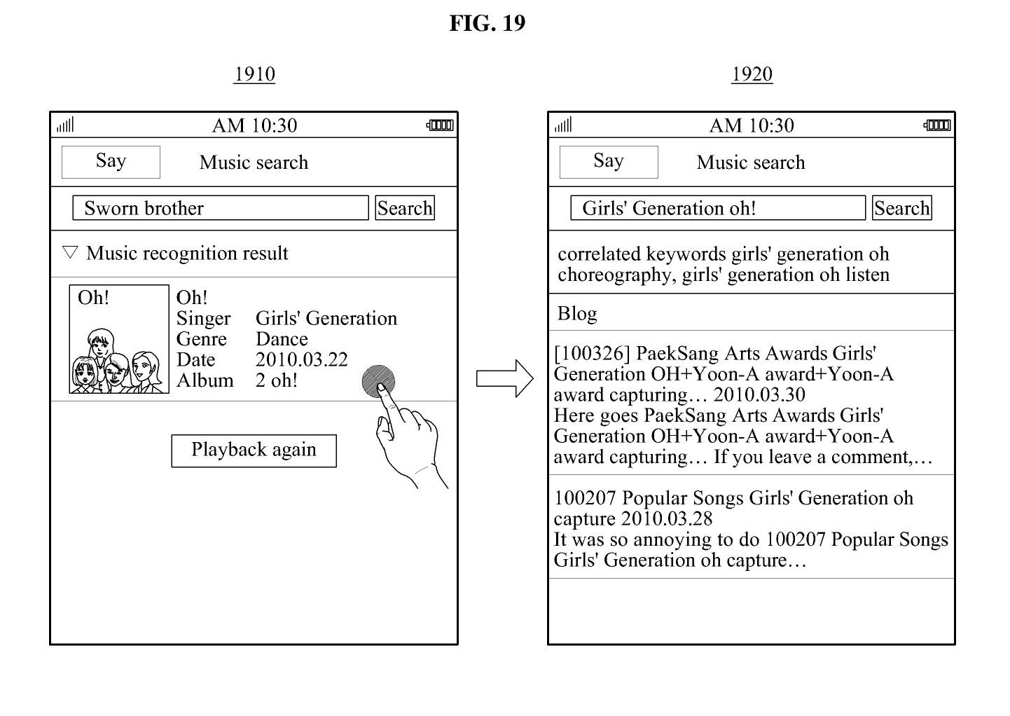

FIG. 19 illustrates an exemplary screen for displaying a search result found based on a music search according to exemplary embodiments of the present invention. A first screen 1910 shows an example of displaying, for a user, information about a song found based on recorded music. A second screen 1920 shows an example of displaying, for the user, the search result associated with the song when the found song is selected by the user.

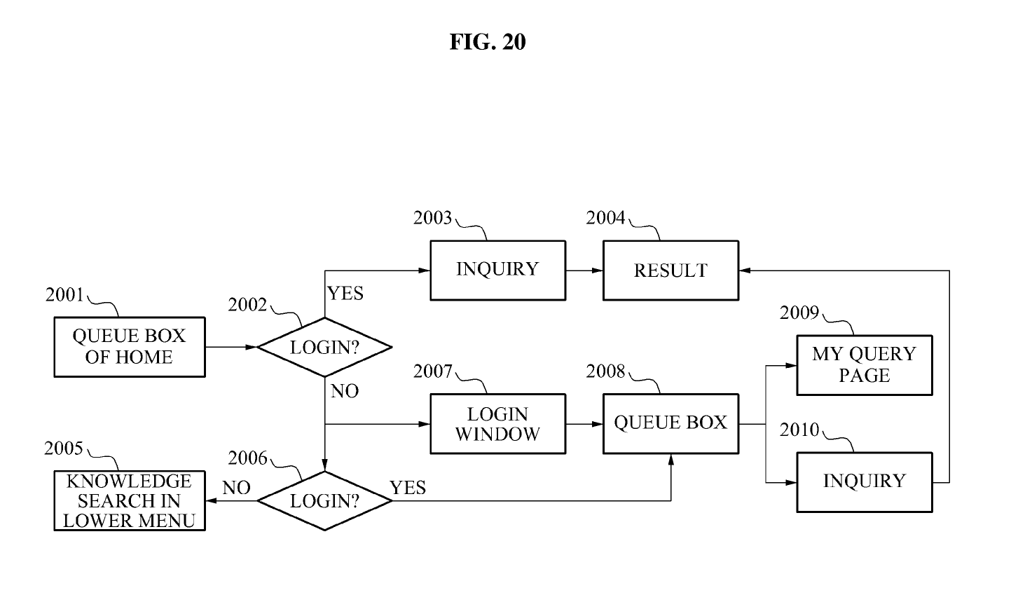

FIG. 20 is a flowchart of a process for illustrating a knowledge search method according to exemplary embodiments of the present invention. When a user selects a queue box 2001 of Home or a knowledge search 2005 in a lower menu of Home, a knowledge search mode may be selected. The queue box 2001 may correspond to the field 331 of FIG. 3, and the knowledge search 2005 may correspond to the interface of the knowledge search included in the fifth dotted box 350 of FIG. 3. The knowledge search mode may proceed after basically verifying the user through login operations 2002 and 2006 in order to accurately provide an answer to a query to the user. When the user is not logged in, a login window 2007 may be displayed for the user. When the user is logged in via the login window 2007, a main screen for a queue box 2008 may be displayed for the user.

When the user having accessed using the queue box 2001 of Home selects the queue box 2001 of Home, the mobile system 200 may display a screen for inquiry 2003 for the user and the user may input query data using an interface of the displayed screen. The mobile system 200 may transmit the input query data to the search server and may receive the search result from the search server. The mobile system 200 may display a screen of displaying a search result 2004 for the user. For example, an interface for providing again the screen for the inquiry 2003 may be included in the screen for providing the result 2004.

When the user selects the knowledge search 2005 included in the lower menu of Home, the main screen for the queue box 2008 may be immediately displayed for the user and my query page 2009 for providing the user's queries and answers thereto and a screen for inquiry 2010 may be displayed on the main screen for the user. In this example, when query data is input from the user via the screen for the inquiry 2010, the mobile system 200 may transmit the input query data to the search server and may receive the search result from the search server. The mobile system 200 may display the screen for displaying the result 2004 for the user.

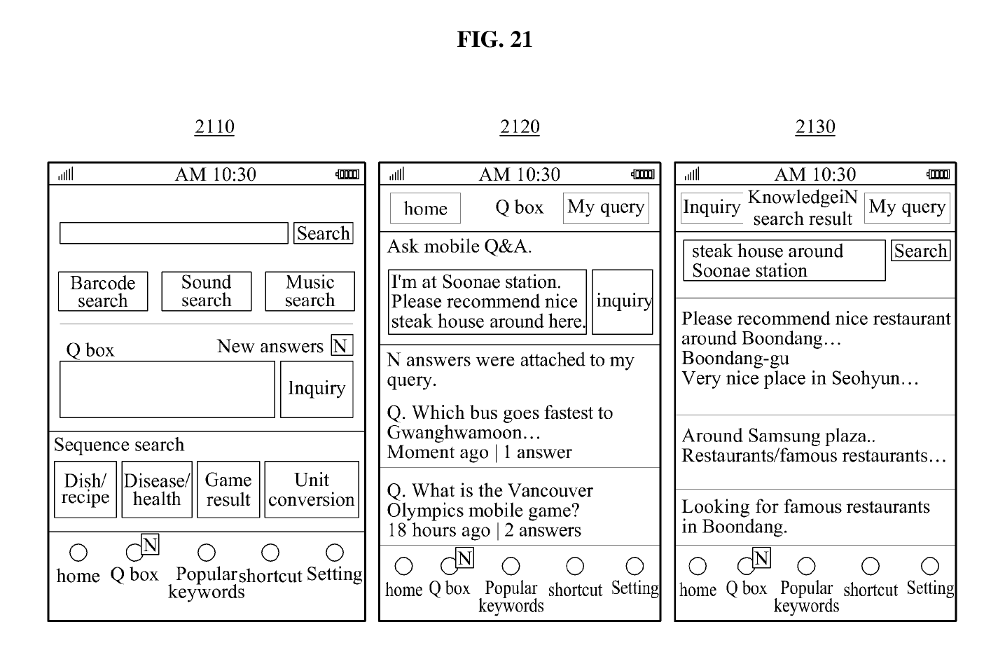

FIG. 21 illustrates an exemplary screen for receiving a query from a user and providing a search result corresponding to the query according to exemplary embodiments of the present invention. A first screen 2110 shows an example of Home. In this exmaple, “new answers N” and “N”, indicated above an interface for a knowledge search included in a lower menu, indicate that answers are uploaded in response to the user's query. A second screen 2120 may correspond to a screen for inputting query data, and shows an example of displaying a field for inputting query data and information about previous queries. A third screen 2130 shows an example of extracting keyword “steak house around Soonae station” from input query data, and displaying the search result found using the extracted keyword.

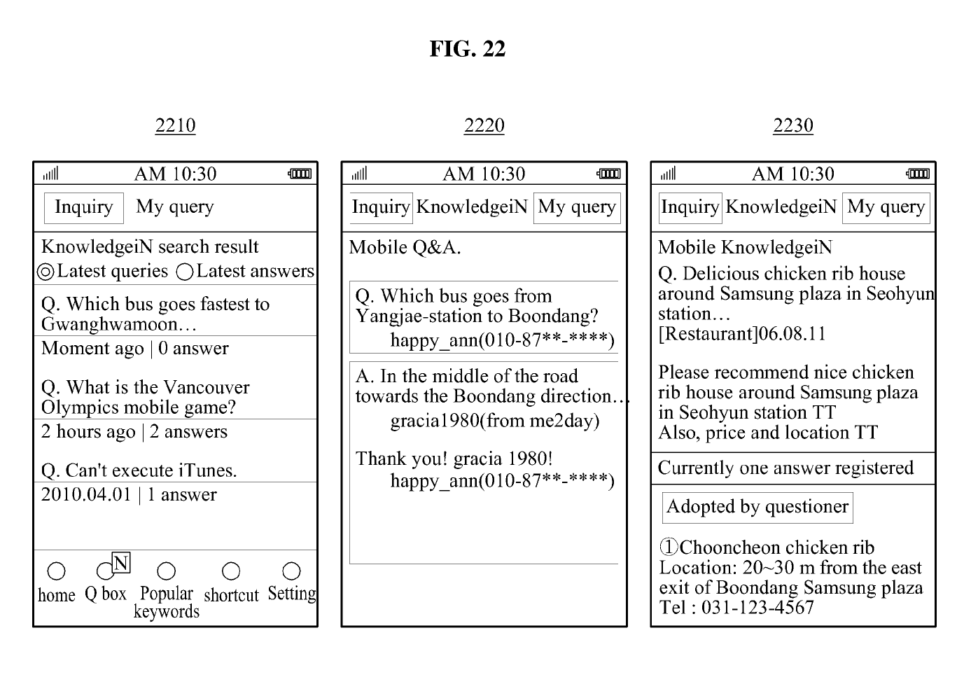

FIG. 22 illustrates an exemplary screen for displaying answers in response to an input query according to exemplary embodiments of the present invention. A first screen 2210 shows an example of displaying queries of a user, and a second screen 2220 and a third screen 2230 show example of displaying answer data to the queries of the user. The second screen 2220 shows an example of displaying the result of knowledge search found based on the received answer data, and the third screen 2230 shows an example of displaying question data and answer data on a page associated with the search server.

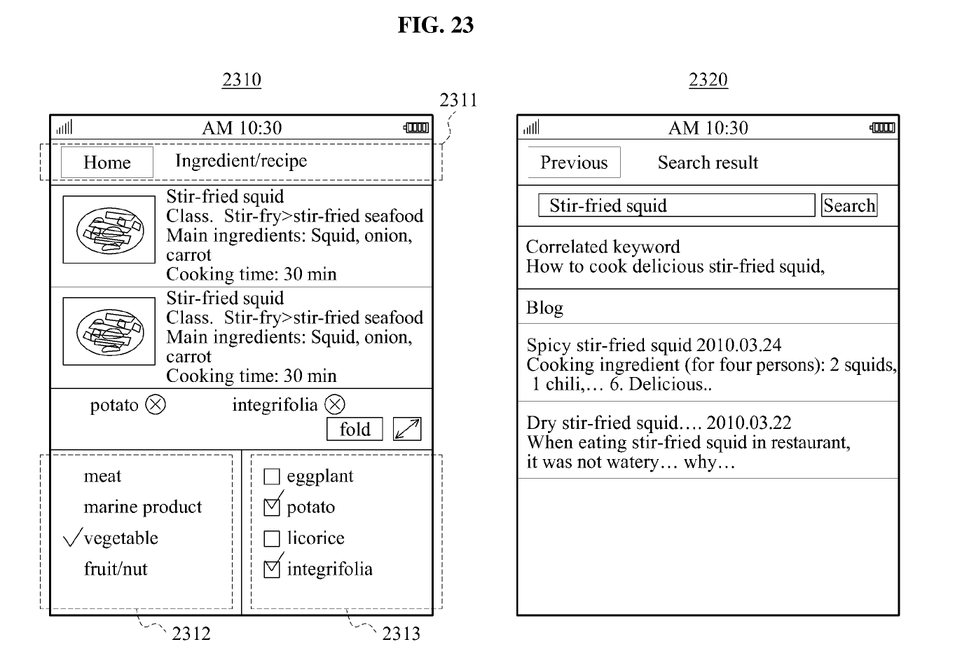

FIG. 23 illustrates an exemplary screen for displaying attributes corresponding to an input subject and displaying a search result about a selected attribute according to exemplary embodiments of the present invention. A first screen 2310 shows an example of providing “meat,” “marine product,” “vegetable,” and “fruit/nut,” as attributes with respect to subject “ingredient/recipe” that is selected from the user, and then sequentially providing “eggplant,” “potato,” “licorice,” and “integrifolia” as attributes associated with the selected “vegetable”. In this example, the first screen 2310 may display the search result about “ingredient/recipe-vegetable-potato/integrifolia” that are the selected subject and attributes. For example, the recipe of a dish using potato and integrifolia as ingredients may be provided as the search result. Also, for example, a thumbnail of a dish image, a dish name, a main ingredient, and cooking time/calories may be provided. Also, the search result may be dynamically changed when the user adds, deletes, or changes the selected attribute.

The second screen 2320 shows an example of displaying the search result found by employing, as a keyword, a text extracted from the search result through an event, for example, clicking on the search result. For example, the second screen 2320 may display a unified search result by employing a keyword,” “stir-fried squid” that is a title of the search result found when the user clicks on the search result about “stir-fried squid” on the first screen 2310.

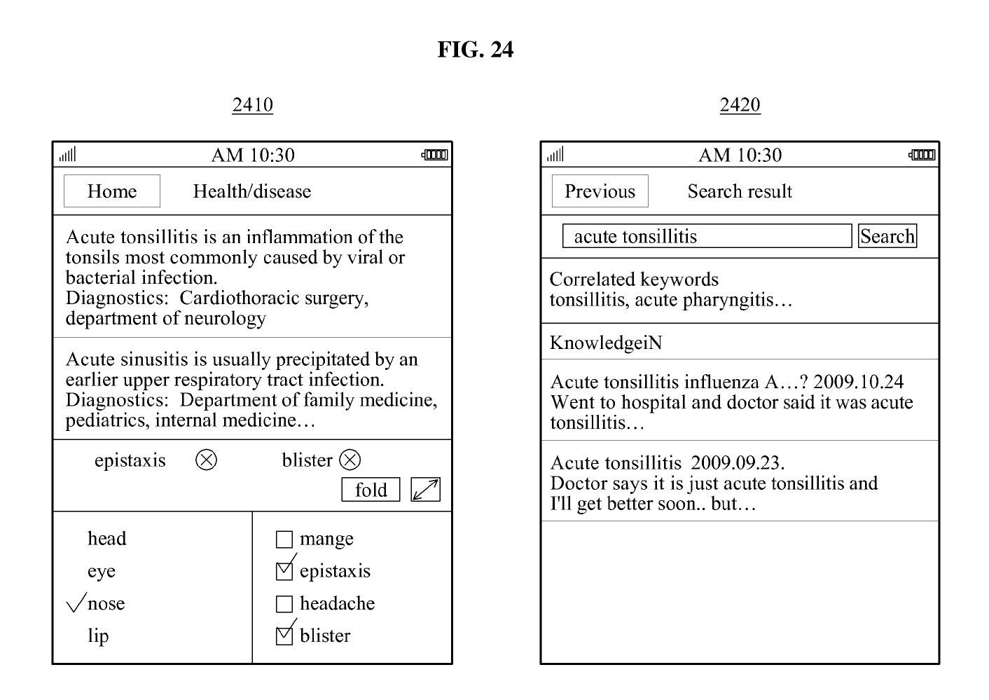

FIG. 24 illustrates an exemplary screen for displaying attributes corresponding to an input subject and displaying a search result about a selected attribute according to exemplary embodiments of the present invention. A first screen 2410 shows an example of providing attributes such as “head,” “eye,” “nose,” and “lip” with respect to subject “health/disease” and then sequentially providing attributes such as “mange,” “epistaxis” “headache” and “blister,” in association with “nose” that is selected from the provided attributes. In this example, the mobile system 200 may provide, as the search result, a disease indicating a symptom of the selected attributes “nose-epistaxis/blister”.

A second screen 2420 shows an example of displaying the search result found by employing, as a keyword, a text extracted from the search result when one search result is selected by the user. For example, the second screen 2420 may display a unified search result about “acute tonsillitis” when the user selects the search result about “acute tonsillitis” on the first screen 2410.

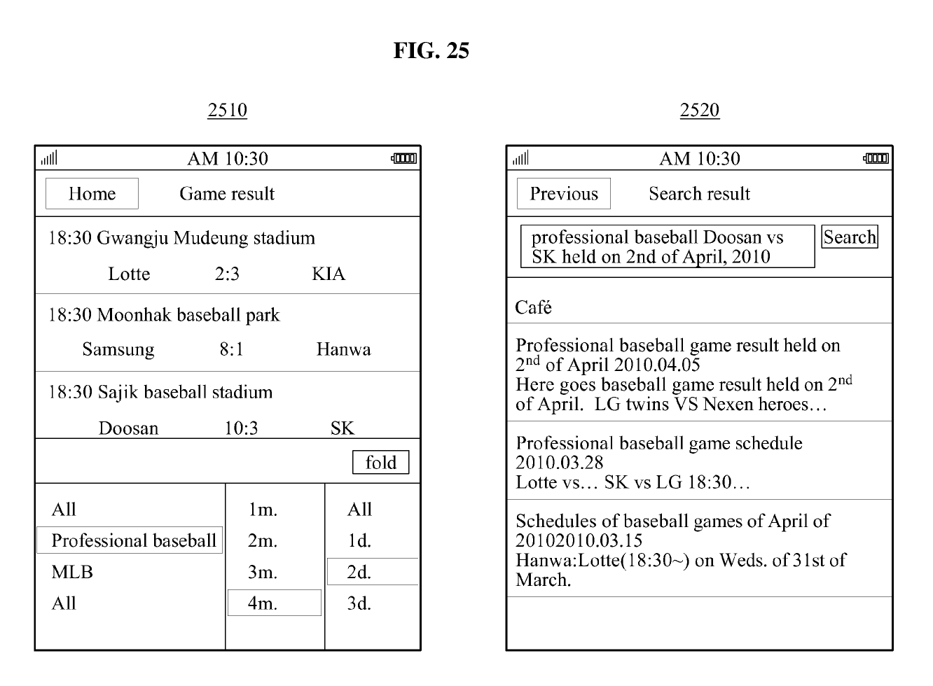

FIG. 25 illustrates an exemplary screen for displaying attributes corresponding to an input subject and displaying a search result about a selected attribute according to exemplary embodiments of the present invention. A first screen 2510 shows an example of providing attributes “baseballs,” “professional baseball,” “MLB,” and “football,” with respect to subject “game result” and providing “month (m)” and “day (d)” as attributes with respect to the selected attribute “professional baseball”. For example, the first screen 2510 may display the search result about professional baseball games that were held on the “second” of “April”.

A second screen 2520 shows an example of displaying a unified search result based on a text “professional baseball Doosan vs SK held on 2^{nd} of April, 2010” extracted from the search result when the user selects the search result about the game between “Doosan” and “SK” on the first screen 2510.

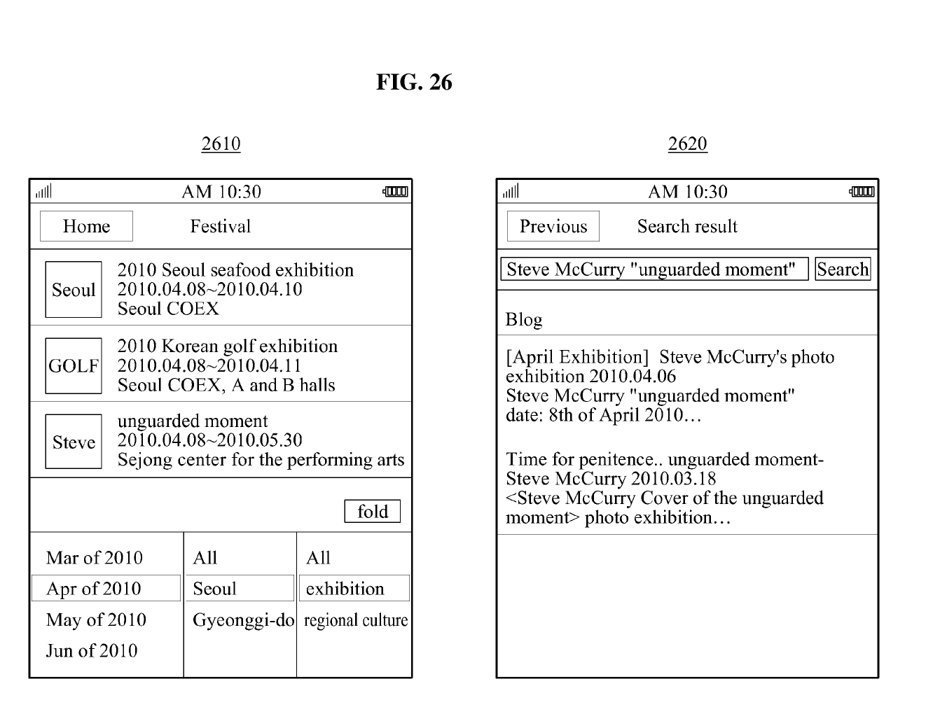

FIG. 26 illustrates an exemplary screen for displaying attributes corresponding to an input subject and displaying a search result about a selected attribute according to exemplary embodiments of the present invention. A first screen 2610 shows an example of sequentially providing attributes, for example, “date,” “region,” and “festival type” with respect to a subject “festival” and providing the search result about the selected attribute. A second screen 2620 shows an example of extracting a text from the search result selected from the provided search result and displaying a unified search results about the extracted text.

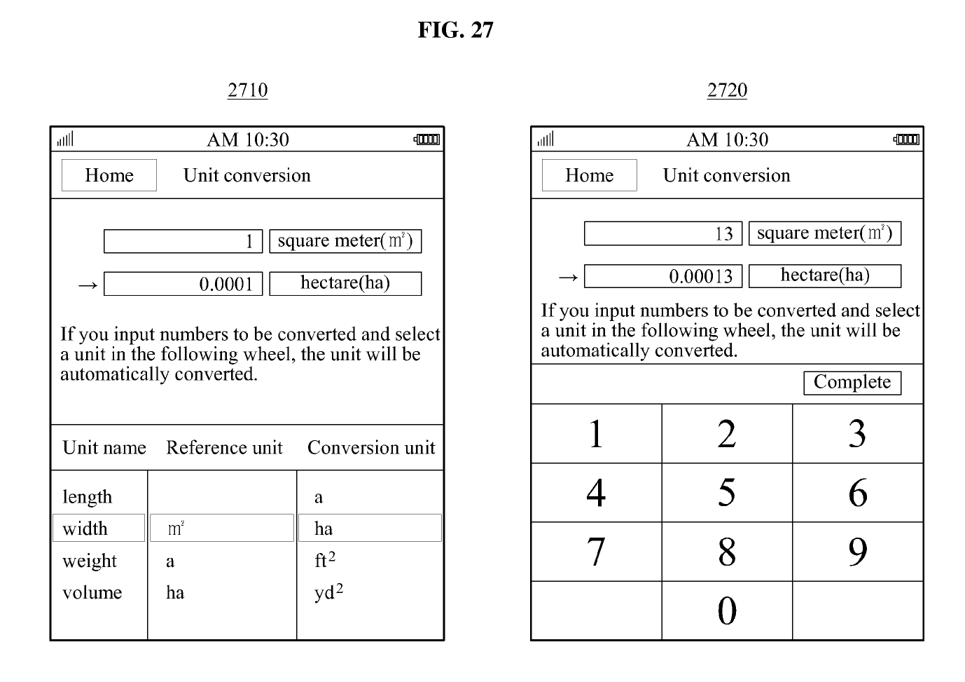

FIG. 27 illustrates an exemplary screen for displaying attributes corresponding to an input subject and displaying a search result about a selected attribute according to exemplary embodiments of the present invention. A first screen 2710 shows an example of sequentially providing attributes, for example, a unit name, a reference unit, and a conversion unit with respect to a subject “unit conversion”. A second screen 2720 shows an example of receiving a value with respect to the reference unit based on the selected attribute and providing a converted value with respect to the input value.

As described above, since the attribute search may sequentially provide various attributes with respect to a given subject and may provide a search result about an attribute selected by a user, it is possible to obtain the search result without a need to input a keyword and the like. In addition, even though a keyword associated with a desired search result is unknown, the desired search result may be readily obtained by selecting an attribute according to the subject.

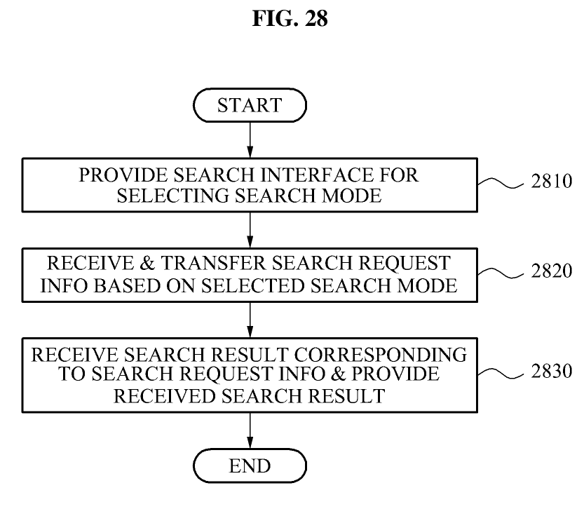

FIG. 28 is a flowchart of a process for illustrating a search result providing method executable at a mobile system according to an exemplary embodiment of the present invention. The search result providing method according to the present embodiment may be performed by the mobile system 200 of FIG. 2.

In step 2810, the mobile system 200 may provide a search interface for selecting a search mode. The search mode may include at least one of (1) an audio search mode for providing a search result corresponding to input audio data, (2) an image search mode for providing a search result corresponding to input image data, (3) a knowledge search mode for providing, as a search result, answer data corresponding to input query data, (4) an attribute search mode for providing a search result that satisfies a criterion according to an attribute of an input subject any combination thereof.

In this example, the audio search mode may include a sound search mode for providing a search result corresponding to a text extracted from the input audio data, and an audio content data search mode for providing a search result about content including at least the input audio data. For example, the sound search mode may be used to extract a text from a sound of a user and to perform search based on the extracted text. In addition, the audio content data search mode may be used to record music coming from a street, and to receive the recorded music as audio data and thereby search for content including the corresponding music or information about the content.

The image search mode may include, for example, an image text based search mode, an image content data search mode, and an image text storage mode.

The image text based search mode may be used to provide the search result corresponding to the text that is extracted from the input image data and thus, may be used to recognize text information included in a photographed pictured and to perform search based on text information. As an example, the image text based search mode may be used to recognize a barcode and search for information about a product corresponding to the barcode. As an example, the image text based search mode may be used to photograph a sign while traveling and search for a lexical meaning of a word included in the sign, or to recognize a sentence written in the sign and automatically translate the sentence.

The image content data search mode may be used to provide the search result about content including at least the input image data. As one example, the image content data search mode may be used to search for information about a corresponding movie based on an image such as a scene of the movie, or to obtain information about a music album based on a photo included in the music album. As an example, the image content data search mode may be used to take a picture of a predetermined building and provide information about the building as a search result, or to provide, as the search result, information about a person using a picture of the person.

The image text storage mode may be used to structuralize the text, extracted from the input image data, for each item and to store the structuralized text. As an example, the image text storage mode may be used to recognize a name card. For example, the image text storage mode may be used to extract, from the photographed name card image, text information such as a name, an address, a telephone number, and a title to structuralize and thereby to store the extracted name, the address, the telephone number, and the title.

The knowledge search mode may be used to provide, as the search result, answer data corresponding to the input query data. The answer data may be displayed on a webpage associated with the search server. When another user uploads answer data with respect to query data that is displayed on the webpage, the answer data may be provided to the user using the mobile system 200.

The attribute search mode may be used to provide the user with attributes about a given subject and to provide search results about attributes selected by the user. The attribute search mode enables the user to obtain a desired search result even though the user is unaware of a keyword required to search for the desired search result. For example, when the user desires to be aware of semi-midsized vehicles having a first grade fuel efficiency and priced between ten million won to twenty million won, the attribute search mode may provide attributes such as a fuel efficiency, a price, and a size under a subject “vehicle,” and the user may obtain search results about vehicles corresponding to the desired attributes. In this example, the user may sequentially select the subject and attributes, for example, “vehicle,” “fuel efficiency,” and “first grade,” and thereby obtain the desired search result. The search result may be provided based on the subject and the attribute. For example, the search result associated with “ingredient/recipe” may be provided as the search result associated with a characteristic of ingredient or the search result about the recipe of a predetermined dish. Also, when a predetermined search result is selected from the user, the mobile system 200 may extract a text from the selected search result and may provide an additional search result by employing the extracted text as a keyword. A method of providing an additional search result will be further described later.

In step 2820, the mobile system 200 may receive search request information based on the search mode selected via the search interface, and may transfer the search request information to the search server. The mobile system 200 may generate search request information for each of various types of data based on various search modes. For example, various types of data such as a text, audio data, and image data may need to be transferred to the search server based on the search mode. For the above operation, the search request information may further include at least information about the search mode selected via the search interface, in addition to data that is to be transferred.

In step 2830, the mobile system 200 may receive a search result corresponding to search request information from the search server, and may provide the search result. For example, as described above, answer data may be displayed on the webpage associated with the search server in the knowledge search mode. In this example, when answer data of another user is displayed on the webpage in response to the query data, the mobile system 200 may receive the answer data as the search result and provide the answer data to the user. In addition, the mobile system 200 may receive, from the search server, the search result corresponding to search request information that is transmitted based on each search mode, and may provide the search result to the user. As an example, when an attribute of a predetermined subject is selected by the user in the attribute search mode, the mobile system 200 may receive, from the search server, the search result that satisfies the criterion according to the selected attribute, and may provide the search result to the user. When the attribute selected by the user is changed, the mobile system 200 may dynamically change the search result based on the changed attribute and thereby provide the dynamically changed search result to the user.

As described above, when one of search results provided via the attribute search mode is selected by the user, the mobile system 200 may extract a text from the selected search result, and perform a unified search by employing the extracted text as a keyword, thereby providing the search result to the user.

The mobile system 200 may perform search using a database included in the mobile system. For example, the database may include various contents stored by the user. The mobile system 200 may search the database based on a search mode and add the received search result to the found search and thereby provide the search result to the user. Also, when no search result is found through searching of the database, the mobile system 200 may also obtain the search result using the search server.

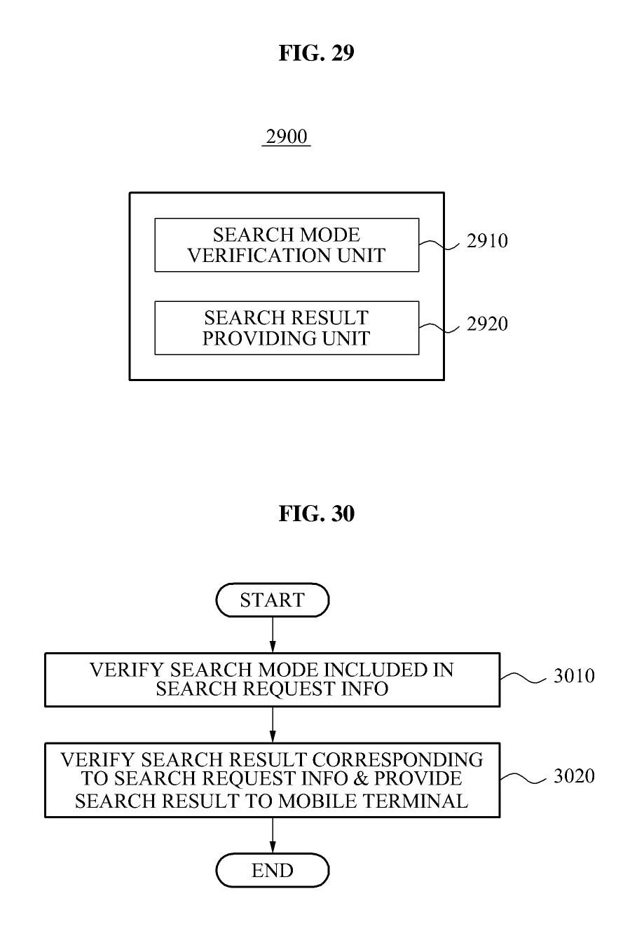

FIG. 29 is a block diagram illustrating an internal configuration of a search system 2900 according to exemplary embodiments of the present invention. The search system 2900, for example, may correspond to the search server 120 of FIG. 1 or the search server described above with reference to FIG. 2 through FIG. 28.

Referring to FIG. 29, for example, the search system 2900 may include a search mode verification unit 2910 and a search result providing unit 2920.

The search mode verification unit 2910 may verify a search mode included in search request information that is received from a mobile terminal. The mobile terminal may correspond to the mobile system 200 described above with reference to FIG. 2 through FIG. 28. For example, the search mode may be selected via a search interface that is provided from the mobile terminal to a user. The mobile terminal may generate search request information based on data that is input based on the search mode and information about the search mode selected via the search interface, and may transmit the search request information to the search system 2900. The search mode verification unit 2910 may verify the search mode included in the search request information. The search mode is described above with reference to FIG. 2 through FIG. 28 and thus, further detailed description will be omitted here to avoid unnecessarily obscuring the present invention.

The search result providing unit 2920 may verify a search result corresponding to the search request information based on the search mode, and may provide the search result to the mobile terminal. In this example, the search result providing unit 2920 may apply a different search scheme based on the verified search mode. For example, since properties of data, transmitted together with the search result information, are different from each other depending on whether the search mode is a sound search mode, and an image search mode, the search result providing unit 2920 may obtain the search result by selecting and applying a search scheme suitable for the search mode. The obtained search result may be transmitted to the mobile terminal and thereby enable the user of the mobile terminal to obtain a desired search result.

FIG. 30 is a flowchart of a process for illustrating a search result providing method executable at a search system according to exemplary embodiments of the present invention. The search result providing method, for example, may be performed by the search system 2900 of FIG. 29.

In step 3010, the search system 2900 may verify a search mode included in search request information that is received from a mobile terminal. The mobile terminal may correspond to the mobile system 200 described above with reference to FIG. 2 through FIG. 28. For example, the search mode may be selected via a search interface that is provided from the mobile terminal to a user. The mobile terminal may generate search request information based on data that is input based on the search mode and information about the search mode selected via the search interface, and may transmit the search request information to the search system 2900. The search mode verification unit 2910 may verify the search mode included in the search request information. The search mode is described above with reference to FIG. 2 through FIG. 28 and thus, further detailed description will be omitted here to avoid unnecessarily obscuring the present invention.

In step 3020, for example, the search system 2900 may verify a search result corresponding to the search request information based on the search mode, and may provide the search result to the mobile terminal. In this example, the search result providing unit 2920 may apply a different search scheme based on the verified search mode. For example, since properties of data, transmitted together with the search result information, are different from each other depending on whether the search mode is a sound search mode, and an image search mode, the search result providing unit 2920 may obtain the search result by selecting and applying a search scheme suitable for the search mode. The obtained search result may be transmitted to the mobile terminal and thereby enable the user of the mobile terminal to obtain a desired search result.

Referring again to FIG. 2, for accuracy of the search result based on each search mode, the mobile system 200 may further use position information according to a position of the mobile system 200. Depending on embodiments, the user is enabled to select whether to use position information.

For example, when the user desires to obtain information about a predetermined building by taking a picture of the predetermined building in an image search mode, the mobile system 200 may additionally transmit information about a position of the predetermined building based on position information according to a position of the mobile system 200, thereby providing more accurate search result. For example, the mobile system 200 may transmit an image of the predetermined building and position information thereof to the search system 2900. In addition to search using the image, the search system 2900 may verify whether corresponding position information is included in the search result, thereby providing a more accurate search result.

For example, when attributes are provided with respect to a subject selected by the user in an attribute search mode, it is possible to provide attributes associated with the subject based on position information of the mobile system 200. When a subject “health/disease” is selected, attributes “near hospital/drugstore/heath center” may be provided to the user. In addition, when the search result is provided based on the attributes, more accurate search result may be provided based on position information of the mobile system 200. For example, when attributes “April of 2010,” “Seoul,” and “exhibition” are selected with respect to a subject “festival,” various search results such as information about exhibitions being held in Seoul in April of 2010 and a way to a corresponding exhibition place from a current position may be further provided.

Such position information may also be used in a sound search mode. In the case of the sound search mode capable of recognizing a sound of the user and providing a search result based on the recognized sound, a function of enabling the user to select whether to use position information may be provided. When the user selects to use the position information, it is possible to enhance the accuracy of sound recognition by comparing the sound and position information, or to transmit the recognized sound and position information to the search system 2900, thereby providing the more accurate search result.

In a knowledge search mode, when the user uploads a query associated with a current position, for example, a query “I'm near Non-hyun station.” Where can I take a bus to Yang-jae station?,” it is possible to display query data and map information indicating the position of the user on a webpage, thereby enabling other users to refer to the information when uploading answer data. Also, when extracting a keyword from the query and providing the search result about the extracted keyword, it is possible to provide the more accurate search result based on position information of the user.

As described above, it is possible to provide the more accurate search result or to enhance the convenience of users by further employing position information for each search mode.

In addition, in the knowledge search mode, it is possible to set query data to be transferred to a predetermined answerer. As an example, when an expert is set for each predetermined field, the search system 2900 may analyze the query data and determine a field associated with a corresponding query and then transfer the query data to an expert of the determined field. As an example, it is possible to transfer the query data to an answerer around the user of the mobile system 200 based on the position information. In this example, to transfer the query data to the predetermined answerer, the search system 2900 may display the query data on a webpage associated with the predetermined answerer. Also, to inform the predetermined answer of that the query data is uploaded, it is possible to transfer, to a terminal of the predetermined answerer, a message indicating that the query data is uploaded to a corresponding page.

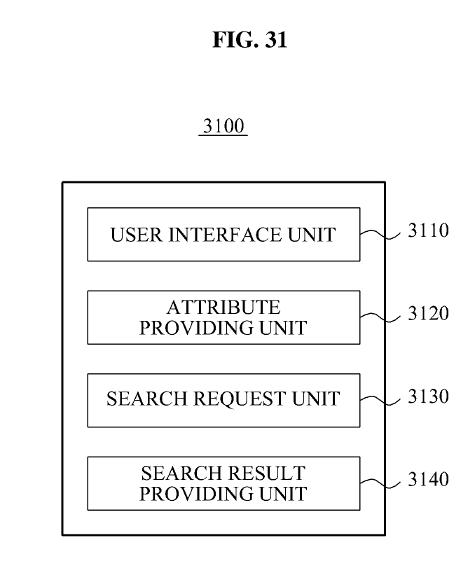

FIG. 31 is a block diagram illustrating a configuration of a mobile system 3100 according to exemplary embodiments of the present invention. Referring to FIG. 31, the mobile system 3100, for example, may include a user interface unit 3110, an attribute providing unit 3120, a search request unit 3130, and a search result providing unit 3140.

The user interface unit 3110 may provide a search interface for selecting a subject of a search. The user interface unit 3110 may provide various subjects using the search interface and may also receive a subject from a user using the search interface.

Using the search interface, the attribute providing unit 3120 may provide at least one attribute that is predetermined based on a subject input via the search interface. One attribute, for example, may include detailed attributes and the user may sequentially select attributes using the search interface. Also, the attribute providing unit 3120 may provide at least one attribute with respect to a single subject and may provide at least one detailed attribute with respect to one attribute. Depths of attributes may be determined based on a corresponding subject. For example, some subjects may include only primary attributes and other subjects may include further detailed attributes of a detailed attribute. A plurality of attributes may be selected from the attributes provided to the user.

The search request unit 3130 may transmit, to the search server, search request information associated with an attribute that is selected from the at least one attribute. For example, the search request information may include information about the attribute selected by the user. As necessary, the search request information may further include subject information.

The search result providing unit 3140 may receive the search result corresponding to search request information from the search server and provide the received search result. The search interface and the search result may be simultaneously displayed on one screen. In this example, when the user selects another attribute using the search interface, the search result providing unit 3140 may dynamically change the search result received from the search server and thereby provide the dynamically changed search result.

When one of the provided search results is selected by the user, the search result providing unit 3140 may extract a text from the selected search result. The extracted text may be transmitted to the search server using the search request unit 3130, and the search server may generate a search result by employing the extracted text as a keyword. The generated search result may be transmitted to the mobile system 3100 and the search result providing unit 3140 may provide the search result to the user. For example, a primary search result may be provided based on a subject and an attribute, and a secondary search result may be provided based on a text extracted from the primary search result.

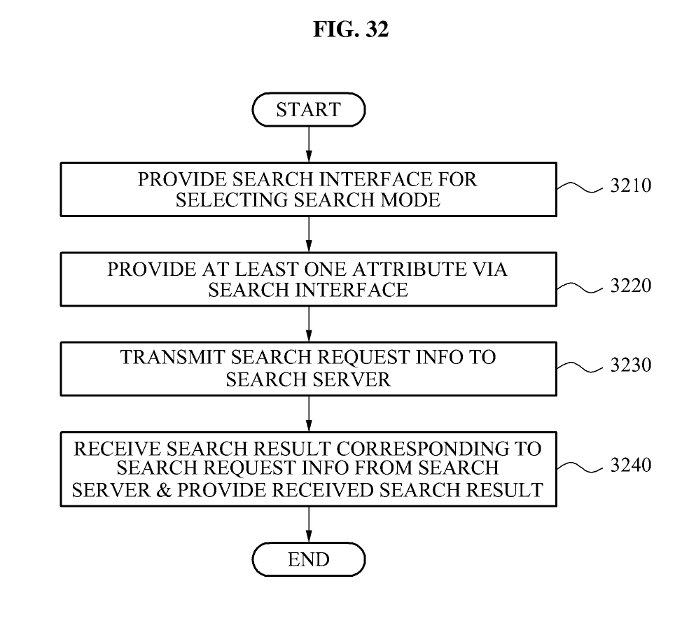

FIG. 32 is a flowchart of a process for illustrating a search result providing method executable at a mobile system according to exemplary embodiments of the present invention. The search result providing method according to the exemplary embodiments of the present invention may be performed by the mobile system 3100 of FIG. 31.

In step 3210, the mobile system 3100 may provide a search interface for selecting a subject of a search. The mobile system 3100 may provide various subjects using the search interface and may also receive a subject from a user using the search interface.

As in step 3220, using the search interface, the mobile system 3100 may provide at least one attribute that is predetermined based on a subject input via the search interface. One attribute may include detailed attributes and the user may sequentially select attributes using the search interface. Also, the mobile system 3100 may provide at least one attribute with respect to a single subject and may provide at least one detailed attribute with respect to one attribute. Depths of attributes may be determined based on a corresponding subject. For example, some subjects may include only primary attributes and other subjects may include further detailed attributes of a detailed attribute. A plurality of attributes may be selected from the attributes provided to the user.

In step 3230, the mobile system 3100 may transmit, to the search server, search request information associated with an attribute that is selected from the at least one attribute. For example, the search request information may include information about the attribute selected by the user. As necessary, the search request information may further include subject information.

In step 3240, the mobile system 3100 may receive the search result corresponding to search request information from the search server and provide the received search result. The search interface and the search result may be simultaneously displayed on one screen. In this example, when the user selects another attribute using the search interface, the mobile system 3100 may dynamically change the search result received from the search server and thereby provide the dynamically changed search result.

When one of the provided search results is selected by the user, the mobile system 3100 may extract a text from the selected search result. The extracted text may be transmitted to the search server using the mobile system 3100, and the search server may generate a search result by employing the extracted text as a keyword. The generated search result may be transmitted to the mobile system 3100 and the mobile system 3100 may provide the search result to the user. For example, a primary search result may be provided based on a subject and an attribute, and a secondary search result may be provided based on a text extracted from the primary search result.

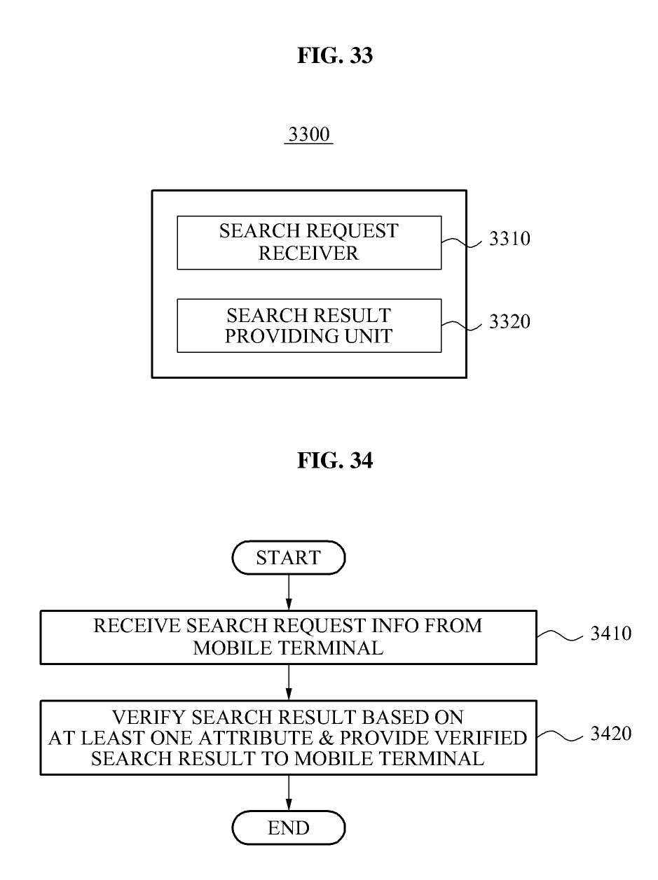

FIG. 33 is a block diagram illustrating an internal configuration of a search system 3300 according to exemplary embodiments of the present invention. The search system 3300 according to the exemplary embodiments of the present invention may correspond to the search server described above with reference to FIG. 31 and FIG. 32. Referring to FIG. 33, the search system 3300 may include a search request receiver 3310 and a search request providing unit 3320.

For example, the search request receiver 3310 may receive search request information from a mobile terminal. The mobile terminal may correspond to the mobile system 3100 described above with reference to FIG. 31 and FIG. 32. For example, the mobile terminal may provide a search interface of selecting a subject of a search, and may provide, using the search interface, at least one attribute that is predetermined based on the subject input via the search interface. Search request information associated with an attribute selected from at least one attribute may be transmitted to the search server, for example, the search system 3300. The search request receiver 3310 may receive search request information from the mobile terminal.

The search result providing unit 3320, for example, may verify a search result based on at least one attribute included in the search request information and may provide the verified search result to the mobile terminal. For example, at least one attribute may include at least one attribute among attributes that are associated with the subject selected at the mobile terminal. For example, the search result providing unit 3320 may generate the search result based on the given attribute and transmit the generated search result to the mobile terminal.

FIG. 34 is a flowchart of a process for illustrating a search result providing method executable at a search system according to exemplary embodiments of the present invention. The search result providing method according to exemplary embodiments of the present invention may be performed by the search system 3300 described above with reference to FIG. 33.

In operation 3410, the search system 3300 may receive search request information from a mobile terminal. The mobile terminal may correspond to the mobile system 3100 described above with reference to FIG. 31 and FIG. 32. For example, the mobile terminal may provide a search interface of selecting a subject of a search, and may provide, using the search interface, at least one attribute that is predetermined based on the subject input via the search interface. Search request information conforming to an attribute selected from at least one attribute may be transmitted to the search server, for example, the search system 3300. The search system 3300 may receive search request information from the mobile terminal.

In step 3420, the search system 3300 may verify a search result based on at least one attribute included in the search request information and may provide the verified search result to the mobile terminal. The at least one attribute may include at least one attribute among attributes that are associated with the subject selected at the mobile terminal. For example, the search system 3300 may generate the search result based on the given attribute and transmit the generated search result to the mobile terminal.

Descriptions not made in FIG. 28 through FIG. 34 may refer to descriptions made above with reference to FIG. 1 through FIG. 27.

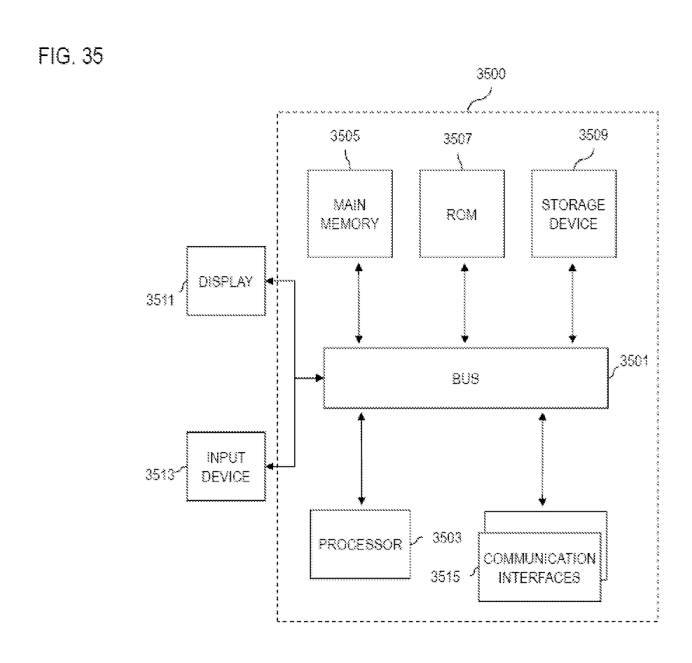

One of ordinary skill in the art would recognize that providing a search service associated with a mobile system may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 35.

FIG. 35 illustrates exemplary hardware upon which various embodiments of the invention can be implemented. A computing system 3500 includes a bus 3501 or other communication mechanism for communicating information and a processor 3503 coupled to the bus 3501 for processing information. The computing system 3500 also includes main memory 3505, such as a random access memory (RAM) or other dynamic storage device, coupled to the bus 3501 for storing information and instructions to be executed by the processor 3503. Main memory 3505 can also be used for storing temporary variables or other intermediate information during execution of instructions by the processor 3503. The computing system 3500 may further include a read only memory (ROM) 3507 or other static storage device coupled to the bus 3501 for storing static information and instructions for the processor 3503. A storage device 3509, such as a magnetic disk or optical disk, is coupled to the bus 3501 for persistently storing information and instructions.

The computing system 3500 may be coupled via the bus 3501 to a display 3511, such as a liquid crystal display, or active matrix display, for displaying information to a user. An input device 3513, such as a keyboard including alphanumeric and other keys, may be coupled to the bus 3501 for communicating information and command selections to the processor 3503. The input device 3513 can include a cursor control, such as a mouse, a trackball, or cursor direction keys, for communicating direction information and command selections to the processor 3503 and for controlling cursor movement on the display 3511.

According to various embodiments of the invention, the processes described herein can be provided by the computing system 3500 in response to the processor 3503 executing an arrangement of instructions contained in main memory 3505. Such instructions can be read into main memory 3505 from another computer-readable medium, such as the storage device 3509. Execution of the arrangement of instructions contained in main memory 3505 causes the processor 3503 to perform the process steps described herein. One or more processors in a multi-processing arrangement may also be employed to execute the instructions contained in main memory 3505. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 3500 also includes at least one communication interface 3515 coupled to bus 3501. The communication interface 3515 provides a two-way data communication coupling to a network link (not shown). The communication interface 3515 sends and receives electrical, electromagnetic, or optical signals that carry digital data streams representing various types of information. Further, the communication interface 3515 can include peripheral interface devices, such as a Universal Serial Bus (USB) interface, a PCMCIA (Personal Computer Memory Card International Association) interface, etc.

The processor 3503 may execute the transmitted code while being received and/or store the code in the storage device 3509, or other non-volatile storage for later execution. In this manner, the computing system 3500 may obtain application code in the form of a carrier wave.

The term “computer-readable medium” as used herein refers to any medium that participates in providing instructions to the processor 3503 for execution. Such a medium may take many forms, including but not limited to non-volatile media, volatile media, and transmission media. Non-volatile media include, for example, optical or magnetic disks, such as the storage device 3509. Volatile media include dynamic memory, such as main memory 3505. Transmission media include coaxial cables, copper wire and fiber optics, including the wires that comprise the bus 3501. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

As described above, according to exemplary embodiments of the present invention, it is possible to readily provide various search modes, for example, a text search, an audio search for obtaining a search result using a sound or searching for music, an image search for obtaining a search result using a word included in a picture or using the picture, a knowledge search for obtaining answers of other users about a query, an attribute search for obtaining a search result using an attribute suitable for a subject input by a user. Also, by providing various types of subjects and attributes suitable for a subject input by a user, it is possible to perform a search using a given subject and a selection of an attribute and to reduce difficulties occurring in input and output of a mobile terminal.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

Also, according to exemplary embodiments of the present invention, by providing various types of subjects and attributes suitable for a subject input by a user, it is possible to perform a search using a given subject and a selection of an attribute and to reduce difficulties occurring in input and output of a mobile terminal.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system to communicate with a search server over a wireless network, the system comprising:
a user interface unit to provide a search interface for selecting a search mode;
a search request unit to receive a search request based on the selected search mode via the search interface, and to transfer the search request to the search server, wherein various contents are stored in a non-transitory storage medium of the search server; and
a search result providing unit to receive a search result corresponding to the search request from the search server, and to provide the search result, the search result being searched from the non-transitory storage medium,
wherein the search mode comprises an audio search mode to provide a search result corresponding to input audio data, an image search mode to provide a search result corresponding to input image data.

2. The system of claim 1, wherein the audio search mode comprises a sound search mode to provide a search result corresponding to a text extracted from the input audio data, and an audio content data search mode to provide a search result about content comprising at least the input audio data.

3. The system of claim 1, wherein the image search mode comprises an image text based search mode to provide a search result corresponding to a text extracted from the input image data, and an image content data search mode to provide a search result about content comprising at least the input image data.

4. The system of claim 1, wherein the image search mode comprises an image text storage mode to structure text data extracted from the input image data and to store the structured text data.

5. The system of claim 1, wherein
the search mode further comprises a knowledge search mode to provide answer data corresponding to input query data, and
the search result providing unit to receive, as the search result, the answer data that is displayed on the webpage in correspondence to the query data, and to provide the received answer data.

6. The system of claim 1, wherein
the search mode further comprises an attribute search mode to provide a search result that satisfies a criterion according to an attribute of a subject of an input search request,
in response to detection of the attribute search mode being selected, the user interface unit to verify the input search request with at least one attribute being selected by a user from one or more attributes according to the subject of the input search request,
the search result providing unit to provide a search result according to the verification associated the selected attribute, and
in response to detection of the attribute selected by the user being changed, the search result providing unit to change the search result and to provide the changed search result.

7. The system of claim 6, wherein the user interface unit to extract a text from a search result being selected according to the verification associated with at least one attribute, and
the search result providing unit to receive a search result represented by the extracted text as a keyword via the search server, and to provide the received search result.

8. The system of claim 1, wherein the search request information comprises at least information about a search mode being selected via the search interface.

9. An apparatus using a processor and a non-transitory storage medium to communicate with a terminal for providing a search service, the apparatus comprising:
a search mode verification unit, executed by the processor, to determine a search mode of search request information being received from the terminal; and
a search result providing unit, executed by the processor, to verify a search result corresponding to the search request information based on the search mode, and to provide the verified search result by searching the verified search result from the non-transitory storage medium to the terminal,
wherein the search mode comprises an audio search mode to provide a search result corresponding to input audio data, and an image search mode to provide a search result corresponding to input image data.

10. A system for providing a search service associated with a terminal, the system to communicate with a search server comprising a processor and a non-transitory storage medium over a wireless network, the system comprising:
a user interface unit to provide a search interface to select a subject of a search;
an attribute providing unit to provide, using the search interface, one or more attributes being predetermined based on a subject of an input search request via the search interface;
a search request unit to transmit, to the search server, the search request according to the attribute selected from the one or more attributes; and
a search result providing unit to receive a search result corresponding to the search request from the search server, and to provide the search result, the search result being determined by searching the search request corresponding to the selected attribute from the non-transitory storage medium.

11. The system of claim 10, wherein
the search interface and the search result are simultaneously displayed on a single screen, and
in response to detection of another attribute being selected via the search interface, the search result providing unit to change the displayed search result based on a search result via the search server according to the other attribute, and to provide the changed search result.

12. A search system using a search server comprising a processor and a non-transitory storage medium to communicate with a terminal to provide search services, the search system comprising:
a search request receiver, executed by the processor, to receive search request information from the terminal; and
a search result providing unit, executed by the processor, to verify a search result by searching the search result from the non-transitory storage medium, the searching being performed according to at least one attribute of the search request information, and to provide the search result to the terminal,
wherein the at least one attribute comprises at least one attribute among attributes associated with a subject of a search being selected by the terminal.

13. A method using a processor for providing a search result in a system via a wireless network, the method comprising:
providing a search interface for selecting a search mode;
receiving search request information based on the search mode selected via the search interface to transfer the search request information to a search server; and
receiving a search result corresponding to the search request information by searching, by the processor, the search request information according to the selected search mode to provide the search result,
wherein the search mode comprises an audio search mode ro provide a search result corresponding to input audio data, an image search mode to provide a search result corresponding to input image data, or both the audio search mode and the image search mode.

14. A method of providing a search service using a search server to a terminal via a network, the method comprising:
determining, by a processor, a search mode associated with search request information being received from the terminal; and
verifying, by the processor, whether a search result corresponding to the search request information is matched with the search mode to provide the search result to the mobile terminal,
wherein the search mode comprises an audio search mode for providing a search result corresponding to input audio data, an image search mode for providing a search result corresponding to input image data, or both the audio search mode and the image search mode.

15. A method using a processor for providing a search service associated with a system via a wireless network, the method comprising:
providing a search interface to select a subject of a search category;
generating a plurality of attributes, by a processor, using the search interface in response to detection of a search request corresponding to the search category;
transmitting the search request according to the attribute being selected from the plurality of the attributes; and
receiving a search result corresponding to the search request to provide the search result.

16. A computer-implemented method for providing a search service using a search system to communicate with a terminal, the method comprising:
receiving search request from the terminal; and
providing one or more attributes corresponding to the received search request, the one or more attributes being provided based on determining, by a processor, a subject of the search request and being selected by an user using an interface to verify the search request,
wherein a search result is provided to the user according to the selected attributes.

17. A non-transitory computer-readable storage medium comprising an executable program, which when executed, performs the method of claim 13.
